(19) United States
(12) Patent Application Publication
(10) Pub. No.: US 2018/0211560 A1
(43) Pub. Date: Jul. 26, 2018

(54) LANGUAGE PRACTICE DEVICE, LANGUAGE TEACHING MATERIAL, AND LANGUAGE PRACTICE PROGRAM

(71) Applicant: Derek Yakiwchuk, Tokyo (JP)

(72) Inventor: Derek Yakiwchuk, Tokyo (JP)

(21) Appl. No.: 15/746,691

(22) PCT Filed: Jul. 21, 2016
(86) PCT No.: PCT/JP2016/071343

§ 371 Date: Jan. 22, 2018

(30) Foreign Application Priority Data
Jul. 23, 2015 (JP) 2015-145488

(51) Int. Cl. G09B 19/06; A63F 13/45; G09B 7/06

(52) U.S. Cl. CPC G09B 19/06; G09B 7/066; A63F 13/45

(57) ABSTRACT

The present invention has an object to provide an opportunity of efficiently practicing a language to a language learner and to maintain motivation of the language learner. A display portion 16 displays a bundle of language cards. On each card, information describing a conversation carried out between a teacher and a learner is written. A direction content card 30 describes information that prescribes a conversation for determining a direction of a ball. A club content card 32 describes information that prescribes a conversation for the learner to determine a type of a golf club. A club distance card 34 describes information that prescribes a conversation for determining a carry of the ball. The teacher or the learner causes the language card to be displayed on the display portion 16 and proceeds with the game based on displayed contents of the language card.

### TECHNICAL FIELD

The present invention relates to a language practice device, a language teaching material, and a language practice program and particularly to a device, a teaching material, and a program for providing an opportunity to use a language to a learner.

### BACKGROUND ART

Needs for learning a foreign language has been increased in many countries in the world. A foreign language learner practices conversations, reading and writing of a foreign language in a school in many cases. A foreign language is practiced by using a communication medium such as the Internet, television, radio and the like or a recording medium such as a video disc, a compact disc and the like in some cases. In recent years, various foreign language education methods, foreign language practice devices, and foreign language teaching materials have been conceived of. For example, the following Patent Literatures 1 to 11 describe tools for practicing a foreign language.

### CITATION LIST

### Patent Literature

Patent Literature 1: U.S. Pat. No. 5,458,338

Patent Literature 2: U.S. Pat. No. 6,076,828

Patent Literature 3: U.S. Pat. No. 7,604,236

Patent Literature 4: U.S. Pat. No. 4,890,844

Patent Literature 5: U.S. Pat. No. 6,341,958

Patent Literature 6: U.S. Pat. No. 7,591,721

Patent Literature 7: U.S. Pat. No. 4,171,816

Patent Literature 8: U.S. Patent Laid-Open No. 2007/0015121

Patent Literature 9: U.S. Pat. No. 6,741,833

Patent Literature 10: U.S. Pat. No. 7,058,354

Patent Literature 11: U.S. Pat. No. 7,524,191

### SUMMARY OF INVENTION

### Technical Problem

In the foreign language practice tools described in the aforementioned Patent Literatures 1 to 11, consideration to provide an opportunity to efficiently practice a foreign language to a language learner and to maintain the motivation of the learner (motivation to learn) is lacking.

The present invention has an object to provide an opportunity to efficiently practice a language to a language learner and to maintain the motivation of the language learner.

### Solution to Problem

The present invention is characterized by including a question providing portion configured to provide a question to a learner in a language to be learned, an answer recognition portion configured to recognize an answer to the question, and an execution portion configured to execute a game based on the answer, and the execution portion executes element steps constituting the game based on a linguistic evaluation of the answer.

Preferably, the element step includes an advancing step for determining an advancing direction or an advancing distance of a piece used in the game based on the linguistic evaluation of the answer and a position determining step for determining a position of the piece in accordance with the advancing step, and the question providing portion provides a question element for determining the advance direction or a question element for determining the advancing distance as the question.

Moreover, the present invention is characterized by including a bundle of cards including a plurality of cards and a field on which a figure representing a progress state of the game is shown, and each of the cards describes a question to the learner or information for identifying the question to the learner determined in advance, and the question includes contents for executing the element steps constituting the game.

Preferably, the element steps include the advancing step for determining the advancing direction or the advancing distance of the piece on the field, and the question includes a question element for determining the advancing direction or the advancing distance.

Moreover, the present invention is characterized by having a computer executing question providing processing of providing a question to the learner in the language to be learned, answer recognition processing of recognizing the answer to the question, and execution processing of executing the game based on the answer, and the execution processing is processing of executing the element steps constituting the game based on the linguistic evaluation of the answer.

### Advantageous Effect of Invention

According to the present invention, an opportunity to efficiently practice a language can be provided to a language learner and the motivation of the language learner can be maintained.

### BRIEF DESCRIPTION OF THE DRAWINGS

FIG. 1 is a view illustrating a foreign language practice device according to an embodiment of the present invention.

FIG. 2 is a view illustrating an example of a game field and a piece displayed on a display portion.

FIG. 3 is a view illustrating an example of an image displayed on the display portion during progress of a golf game.

FIG. 4A is a view illustrating an example of a direction content card displayed on the display portion.

FIG. 4B is a view illustrating an example of a club content card displayed on the display portion.

FIG. 4C is a view illustrating an example of a club distance card displayed on the display portion.

FIG. 5 is a view illustrating processing executed by the foreign language practice device for a learner.

FIG. 6 is a view exemplifying a selected language card and game progress state.

FIG. 7 is a view illustrating an example of conversation carried out by using each of the language cards.

FIG. 8 is a view exemplifying an evaluation sheet.

FIG. 9 is a view exemplifying a flow of the conversation when an OK question card is added in addition to the direction content card and club content card.

FIG. 10 is a view illustrating an example in which two parts of conversion are carried out in comparison with one part of conversation.

FIG. 11A is a view illustrating a plurality of types of questions illustrated by the direction content card and the club content card.

FIG. 11B is a view illustrating a plurality of types of questions illustrated by the direction content card and the club content card.

FIG. 11C is a view illustrating a plurality of types of questions illustrated by the direction content card and the club content card.

FIG. 11D is a view illustrating a plurality of types of questions illustrated by the direction content card and the club content card.

FIG. 12 is a view illustrating a variation of the questions.

FIG. 13 is a view illustrating an example of a complex cards used in a one-card game.

FIG. 14 is a flowchart of the golf game.

FIG. 15 is a view illustrating a play surface as the game field.

FIG. 16 is a flowchart of a language and shopping cycle.

FIG. 17A is a view illustrating an example of a course design.

FIG. 17B is a view illustrating an example of the course design.

### DESCRIPTION OF EMBODIMENT

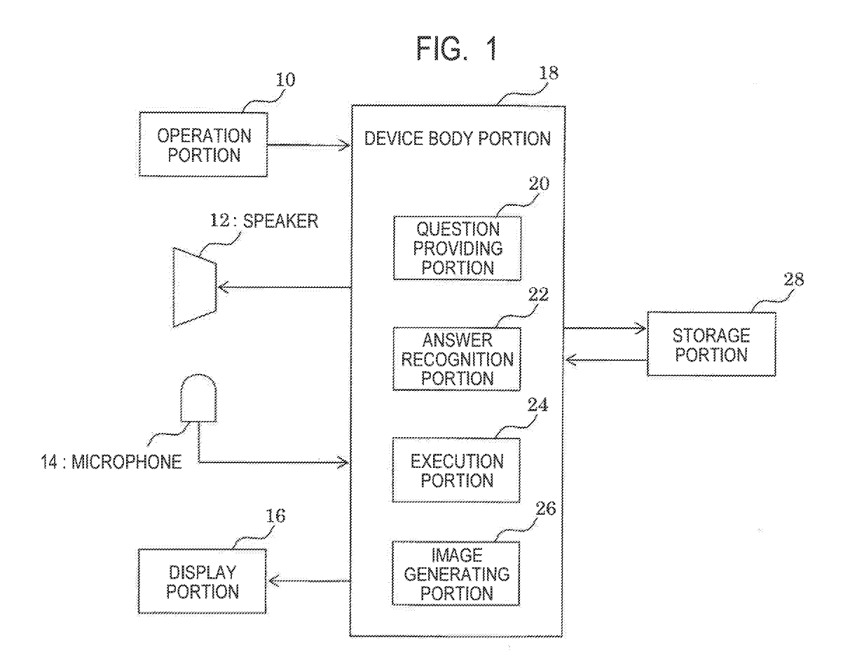

FIG. 1 illustrates a foreign language practice device according to an embodiment of the present invention. The foreign language practice device promotes a conversation between a teacher and a learner and carries out the conversation with the learner by voice recognition processing. The foreign language practice device proceeds with a game in accordance with an evaluation result of the conversation input by the teacher or the evaluation result by the device itself. The foreign language practice device includes a device body portion 18, a storage portion 28, an operation portion 10, a speaker 12, a microphone 14, and a display portion 16. The device body portion 18 includes an electric circuit for connecting the operation portion 10, the speaker 12, the microphone 14, and the display portion 16. The operation portion 10 may include an input device such as a mouse, a keyboard, a trackball and the like. The display portion 16 includes a device such as a display and the like for displaying an image. The display portion 16 may be a touch screen including a static capacitance sensor as a part of the operation portion 10. Moreover, the display portion 16 may be a device for projecting a hologram.

The device body portion 18 is constituted by a computer. The device body portion 18 executes the following processing based on a foreign language practice program stored in the storage portion 28. That is, the device body portion 18 displays a question in a foreign language on the display portion 16 in accordance with an operation in the operation portion 10. The teacher reads out the displayed question, and the learner answers to the question in a voice. The teacher evaluates fluentness, accuracy and the like of the answer and inputs the evaluation results into the device body portion 18 by the operation of the operation portion 10. The evaluation of fluentness of the answer includes smoothness of pronunciation and the like other than a speed of the answer. The device body portion 18 proceeds with the game in accordance with the evaluation result.

Here, instead of the question and evaluation by the teacher, the device body portion 18 may carry out the question and evaluation based on the execution of the foreign language practice program. That is, the device body portion 18 outputs a question from the speaker 12 in accordance with the operation in the operation portion 10. The learner answers to the question by voice. The device body portion 18 recognizes the voiced detected by the microphone 14, evaluates fluentness, accuracy and the like of the answer and proceeds with the game in accordance with the evaluation result. In a progress of the game, the device body portion 18 displays guidance information to the learner or the teacher and the progressing state of the game on the display portion 16.

The game is played by using a game field illustrating figures such as a start, a goal, a course and the like as figures for indicating the advancing state. For example, it is assumed that a piece placed on the game field is moved only for a direction and a distance according to the evaluation result each time the conversation is evaluated so that the piece should reach the goal by as less conversation as possible. Such a game includes a golf game, for example. The game field and the piece may be provided as real objects separately from the foreign language practice device or may be displayed as an image on the display portion 16. If the game field is to be real, the game field may be formed in a sheet state by paper, vinyl, rubber or the like or may be formed in a board state by plastic, wood or the like. The game field may be a magnet board, a cork board, a white board, a blackboard and the like.

Constitution of the device body portion 18 and processing executed by the device body portion 18 will be described. A processor included in the device body portion 18 constitutes a question providing portion 20, an answer recognition portion 22, an execution portion 24, and an image generating portion 26 based on a foreign language practice program stored in the storage portion 28. The question providing portion 20 generates question information based on the operation performed in the operation portion 10. And the question is displayed on the display portion 16 or the question is output from the speaker 12. The answer recognition portion 22 recognizes the answer based on a character input from the operation portion 10 or recognizes the voice detected by the microphone 14 as the answer. The execution portion 24 acquires a position of the piece on the game field based on the answer recognized by the answer recognition portion 22. The image generating portion 26 generates image data according to the progress state of the game and displays an image based on the image data on the display portion 16.

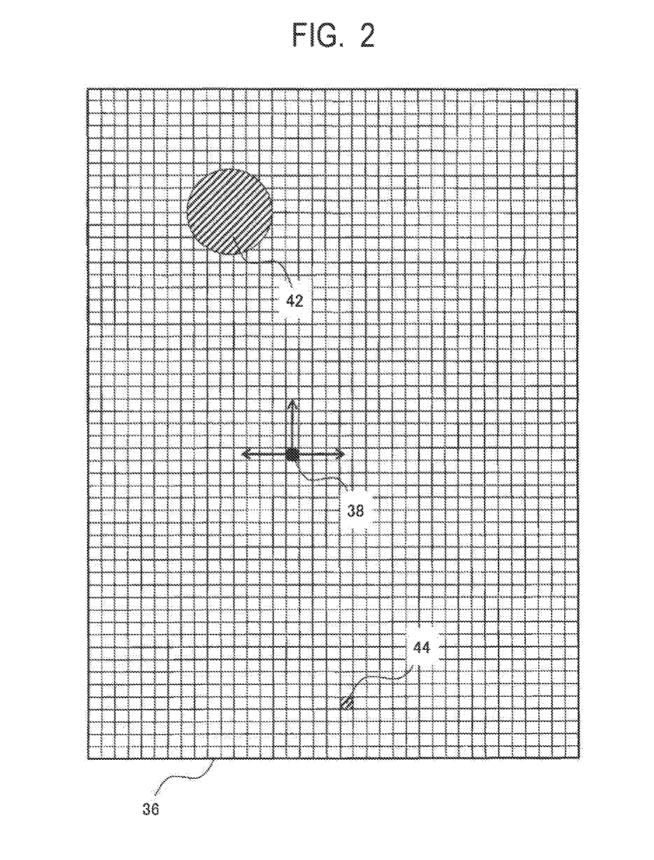

FIG. 2 illustrates an example of a game field 36 and a piece 38 displayed on the display portion 16 during the progress of the game. On the game field 36, a plurality of piece arrangement points is set. In the example illustrated in FIG. 2, a lattice by a plurality of vertical lines drawn in parallel and a plurality of lateral lines drawn in parallel is drawn. One cell in the lattice indicates one piece arrangement point.

When the game is played, first, the piece 38 is placed at a start position 44. Then, each time the conversation is evaluated, the piece 38 is moved only for a direction and a distance (the number of piece arrangement points) according to the evaluation result. A goal region 42 is a region including a plurality of the piece arrangement points. With the conversation and its evaluation, the piece 38 is moved on the game field 36. When the piece 38 enters the goal region 42, the game is finished. When a plurality of the learners play the game, a learner who has his/her piece 38 reach the goal region 42 with the smallest number of conversation times wins the game. Moreover, such a rule may be determined that with the smaller number of conversation times the piece 38 is made to reach the goal region 42, the higher points can be gained so that the game can be enjoyed regardless of the number of the learners.

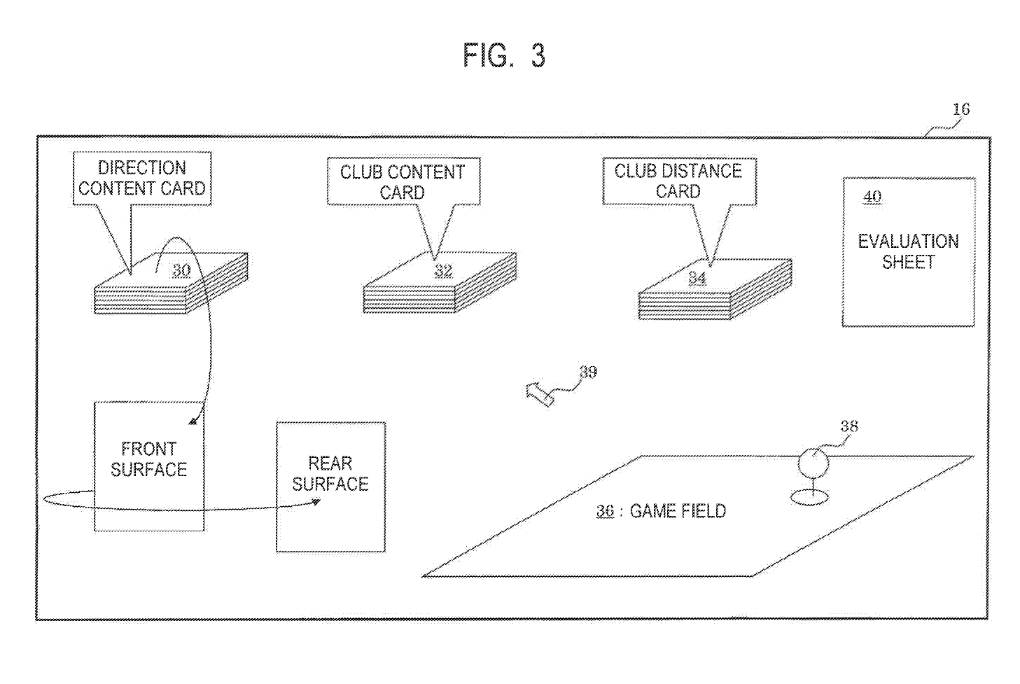

FIG. 3 illustrates an example of an image displayed on the display portion 16 during the progress of the golf game. The display portion 16 displays a bundle of direction content cards 30, a bundle of club content cards 32, and a bundle of club distance cards 34 as bundles of language cards. Each card describes information regulating the conversation carried out between the teacher and the learner. That is, the direction content card 30 describes the information regulating the conversation for determining a direction of a ball. The club content card 32 describes the information regulating the conversation for the learner to determine a type of a golf club. The club distance card 34 describes the information regulating the conversation for determining a ball distance of the ball. For example, on a front of each card, a question read out by the teacher and options of the answer are described, while on a back of each card, information which becomes a guideline for evaluation of the answer by the teacher is described. Description contents of each language card will be described later.

Selection and display of the language card are carried out as follows, for example. That is, a click by a mouse is made in a state where a cursor 39 is matched with the bundle of language cards in a display state, and the front side of the language card is displayed on the display portion 16. In a state where the cursor 39 is matched with the language card and in the display state, when a click by a mouse is further made, the rear side of the language card is displayed on the display portion 16. The teacher and the learner proceed with the game based on display contents of the language card. If the display portion 16 is a touch screen, the selection or the like of the language card is made by contact with a finger of the learner or the teacher instead of a click by the mouse.

If the device body portion 18 in FIG. 1 outputs a question from the speaker 12 and recognizes the answer based on the voice detected by the microphone 14 (hereinafter referred to as voice generation/recognition processing), the operation for selecting the language card is carried out and the device body portion 18 outputs the question from the speaker 12, and recognizes the answer through the microphone 14. In this case, the front and the back of the language card do not have to be displayed on the display portion 16.

On the display portion 16, the game field 36 and the piece 38 are displayed. Here, the piece 38 is a ball. The game field 36 and the piece 38 may be displayed in another window as in FIG. 2.

On an evaluation sheet 40, an evaluation result made for each conversation is described (marked). This description may be made by the operation by the teacher or may be made by the device body portion 18. As will be described later, the direction or ball distance of the ball as the piece 38 may be influenced in accordance with the evaluation result.

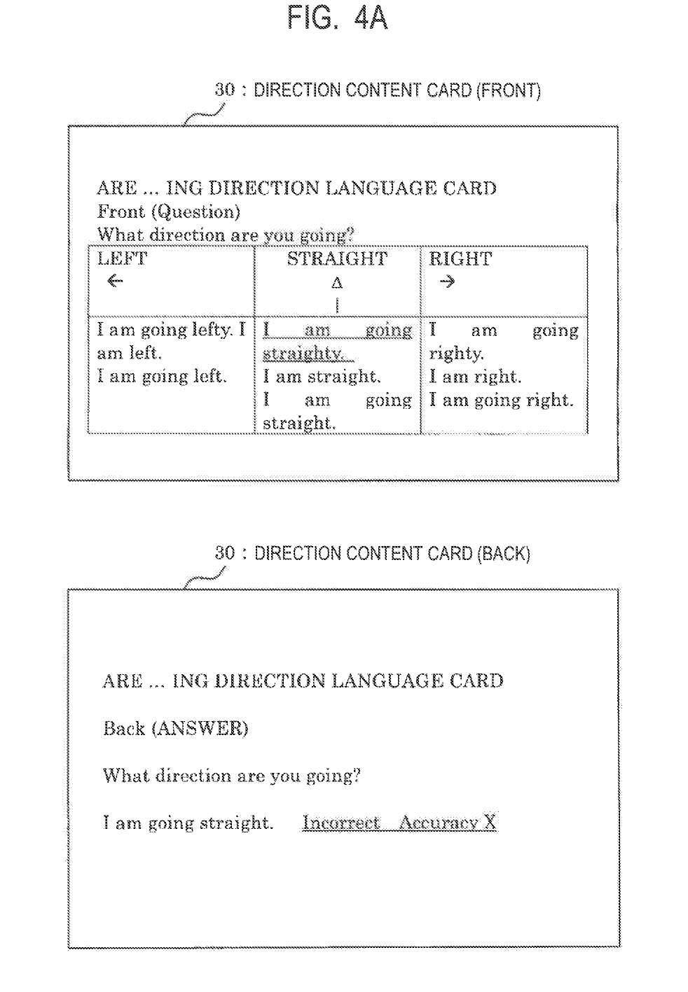

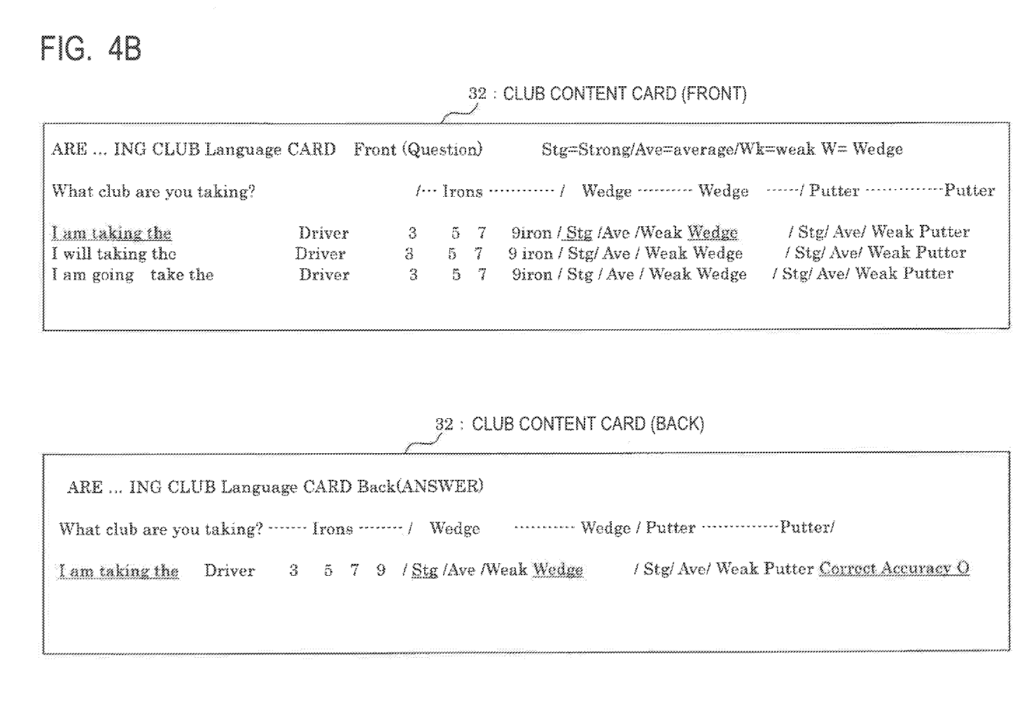

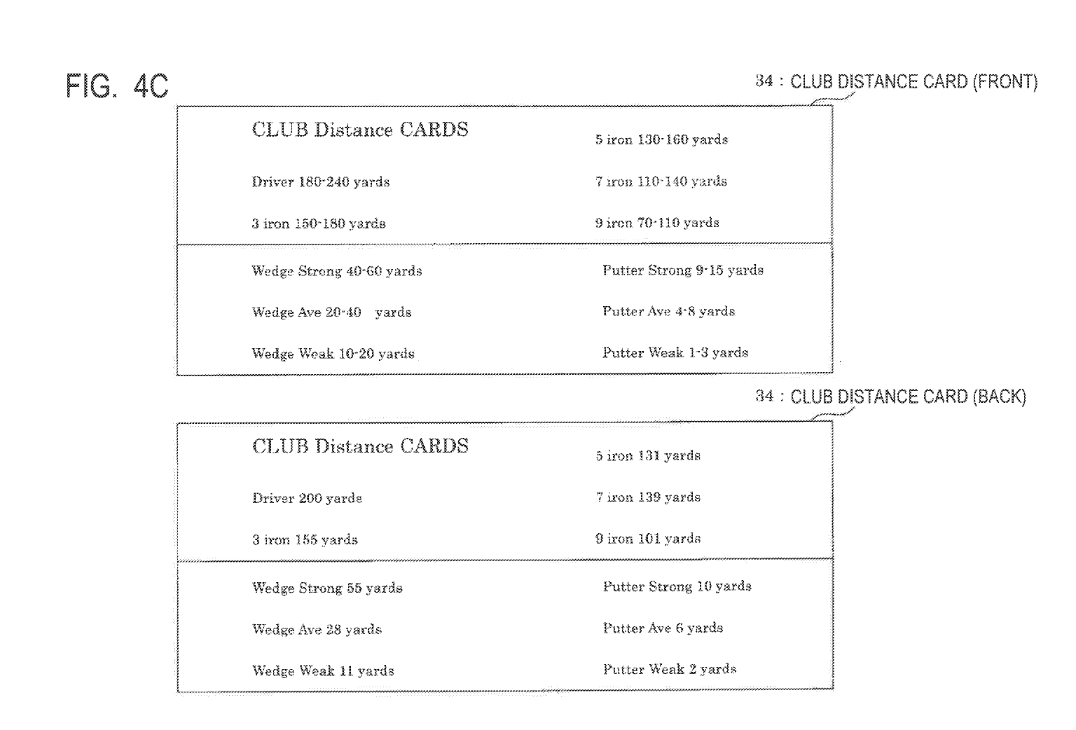

FIG. 4A illustrates an example of the direction content card displayed on the display portion 16. On the front of the direction content card, an English sentence “What direction are you going?” is described as an interrogative sentence for asking a direction in a form of “are ---ing” and this is read out by the teacher. Below that, a plurality of answer options is described. The underlined option of them indicates selection by the operation of the teacher who heard the answer of the learner. On the back, an English sentence “I am going straight.” is described as an example of a correct answer and is referred to by the teacher. Here, the answer by the learner “I am going straighty.” is wrong. Thus, on the back of the direction content card, it is indicated that the learner's answer is wrong by the English sentence “Incorrect Accuracy X” based on the operation by the teacher. Through the conversation using the direction content card, the direction of the ball is determined.

When the device body portion 18 executes the voice generation/recognition processing, before and during the conversation, it may be configured that the front and the back of the direction content card are not displayed. And the front or the back of the direction content card may be displayed after one round of conversation has been made. In this case, the underlined portion in the description on the direction content card may be displayed by the processing of the device body portion 18.

FIG. 413 illustrates an example of the club content card displayed on the display portion 16. On the front of the club content card, an English sentence “what club are you taking?” is described as an interrogative sentence for asking the golf club to be used in the form of “are ---ing” and this is read out by the teacher. On the right thereof, a plurality of answer options is described. The options are a driver, a No. 3 iron, a No. 5 iron, a No. 7 iron, a strong wedge, an average wedge, a weak wedge, a strong putter, an average putter, and a weak putter, and any one of them is to be selected in accordance with the English sentence described on the left of these options. The underlined option indicates selection by the operation of the teacher who heard the answer of the learner. On the back, an English sentence “I am taking the ----” is described as an example of a correct answer and is referred to by the teacher. Here, the answer by the learner “I am taking the Stong Wedge.” is correct. Thus, on the back of the club content card, it is indicated that the learner's answer is correct by the English sentence “Correct Accuracy 0” based on the operation by the teacher. Through the conversation using the club content card, the type of the golf club to be used by the learner is determined.

When the device body portion 18 executes the voice generation/recognition processing, before and during the conversation, it may be configured that the club content card is not displayed. And the club content card may be displayed after one round of conversation has been made. In this case, the underlined portion in the description on the club content card may be displayed by the processing of the device body portion 18.

FIG. 4C illustrates an example of the club distance card displayed on the display portion 16. The club distance card is a card associating the ball distance with the golf club selected by the club content card. The front of the club distance card illustrates that it is a card to 11 types of the golf clubs, that is, the driver, the No. 3 iron, the No. 5 iron, the No. 7 iron, the strong wedge, the average wedge, the weak wedge, the strong putter, the average putter, and the weak putter. On the back of the club distance card, the ball distance is indicated such as “Driver 200 yards”. By means of the club distance card, the ball distance corresponding to the golf club used by the learner is determined. Here, the club distance card collecting the carries for the 11 types of golf clubs is taken up, but the club distance card may be created for each golf club. In this case, 11 bundles of the club distance cards are created.

The contents of the direction content card, the club content card, and the club distance card are stored in the storage portion 28 and are read out as appropriate by the device body portion 18. A question in each card may be a solicitation-type question. The solicitation-type question includes “Why don't you go right?”, “How about going right?”, “Why don't you use the 2 iron?”, “How about using the 2 iron?”, “How do you feed about using the 2 iron” and the like.

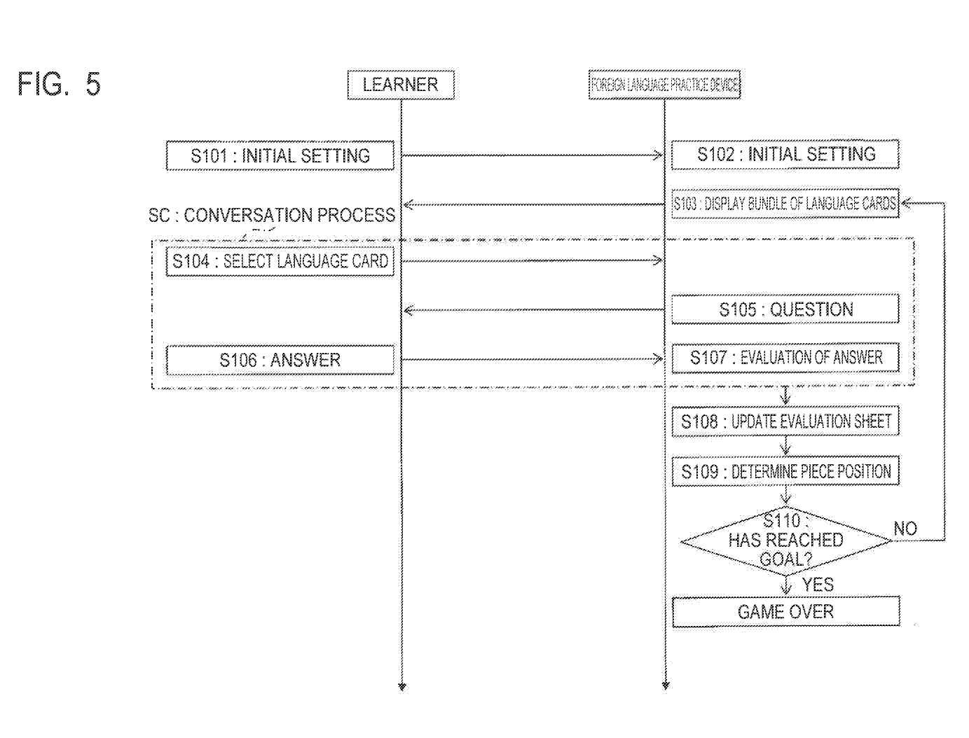

FIG. 5 illustrates a sequence chart of the processing executed by the foreign language practice device for the learner. Here, it is assumed that the device body portion included in the foreign language practice device executes the voice generation/recognition processing.

First, the learner carries out initial setting of the foreign language practice device by the operation on the operation portion (S101 and S102). The initial setting includes setting of an area of the goal region, initialization of the contents of the evaluation sheet and the like. The foreign language practice device displays the bundle of each language card on the display portion (S103).

The learner selects the language card displayed on the display portion by operating the operation portion (S104). This selection is made by clicking by a mouse in a state where the cursor is placed on the language card, for example, if the operation portion includes the mouse. The direction content card, the club content card, and the club distance card are selected in this order in repetition of a conversation process (SC) which will be defined later, but at Step (S104), one of these language cards is selected.

The foreign language practice device outputs the question from the speaker in accordance with the selected language card (S105). The learner answers aloud to the question emitted from the speaker (S106). The foreign language practice device recognizes the voice detected by the microphone and evaluates fluentness, accuracy and the like of the answer (S107). The fluentness includes quickness of the answer and smoothness of pronunciation. The evaluation of the quickness of answer is made by time measured from emission of the question from the speaker until the answer is completed by a timer included in the device body portion 18, for example. Moreover, fluentness (quickness of the answer and smoothness of pronunciation), accuracy and the like may be evaluated based on recognized voice data indicating the voice recognized through the microphone and a degree of approximation to standard voice data stored in the storage portion in advance. In this case, the timer does not have to be used. The degree of approximation between the recognized voice data and the standard voice data can be acquired based on a correlation value between a temporal waveform indicated by the recognized voice data and the temporal waveform indicated by the standard voice data, for example.

The conversation process (SC) including the selection of the language card (S104), the question (S105), the answer (S106), and the evaluation of the answer (S107) is repeated until a plurality of the answers required for determining the position of the piece at the subsequent Step S108 is acquired.

If the game is a golf game, for example, the position of the piece is determined by three conversation processes, that is, the conversation process when the direction content card is selected as the language card, the conversation process when the club content card is selected as the language card, and the conversation process when the club distance content card is selected as the language card.

The foreign language practice device updates the evaluation sheet by reflecting each of the evaluation results in the evaluation sheet (S108), Moreover, the foreign language practice device determines the position of the piece based on the contents of each answer and each evaluation result (S109). For example, if the game is a golf game, determination of the position of the ball as a piece is made based on the direction content card, the club content card, and the club distance content card used in the conversation process. That is, by means of the conversation using these language cards, the direction of the ball and the carry according to the selected golf club are determined, and the position of the ball is determined. As will be described later, a change may be added to the direction and the carry of the ball based on each evaluation result in the conversation process.

When the position of the piece is determined at Step S109 in FIG. 5, the foreign language practice device may execute processing as follows. That is, the foreign language practice device sets an optimal course from the position of the piece 38 at the current point of time in FIG. 2 to the goal region 42. The optimal course is a straight line, for example. When the evaluation in the conversation process is good, a new position of the piece 38 is determined along the optimal course, while if the evaluation in the conversation process is not good, a new position of the piece 38 is determined at a position deviated from the optimal course.

The foreign language practice device determines whether the piece on the game field has reached the goal region or not (S110). If the piece has not reached the goal region, the foreign language practice device returns to the processing at Step S103 and displays each bundle of language cards on the display portion. On the other hand, when the piece has reached the goal region, the foreign language practice device ends the game.

As described above, the device body portion 18 included in the foreign language practice device illustrated in FIG. 1 includes the question providing portion 20 configured to provide a question to the learner in the language to be learned, the answer recognition portion 22 for recognizing the answer to the question, and the execution portion 24 for executing the game based on the answer. The execution portion 24 executes element steps constituting the game based on linguistic evaluation such as fluentness, accuracy and the like of the answer. The element step includes an advancing step for determining a direction (advance direction) of the piece based on the linguistic evaluation of the answer, and the advancing step for determining the ball distance (advance distance) according to the golf club based on the linguistic evaluation of the answer. Moreover, the element step includes a position determining step for determining the position of the piece in accordance with the advancing step. The question providing portion 20 provides a question element for determining the advancing direction or a question element for determining the advancing distance as a question based on the description of the language card.

Here, at Step S107, the example in which the fluentness of the answer (quickness or smoothness of pronunciation) and the accuracy are evaluated was described. The evaluation may be made for at least any one of the quickness of the answer, the smoothness of the pronunciation, and the accuracy.

Moreover, the foreign language practice device may constitute a game in which one of the plurality of learners plays a role of the teacher, and the plurality of the learners including the learner playing the role of the teacher compete with each other. In this case, at least any one of the quickness, smoothness of pronunciation, and accuracy may be evaluated also for the question of the learner playing the role of the teacher. For example, options of expression for the question by the learner with the role of the teacher are described on the fronts of the direction content card and the club content card. On the backs of these cards, which of the options is correct is illustrated so that the evaluation can be made for the question made by the learner with the role of the teacher.

Moreover, by setting the number of options described on the front of each card to two and by indicating which of the two options is correct on the back, an alternative-type test (T/F test) may be carried out. Moreover, on the front of each card, a question in a form filling a blank, a question in a form to find an error, a question in a form of selecting a correct expression and the like may be described.

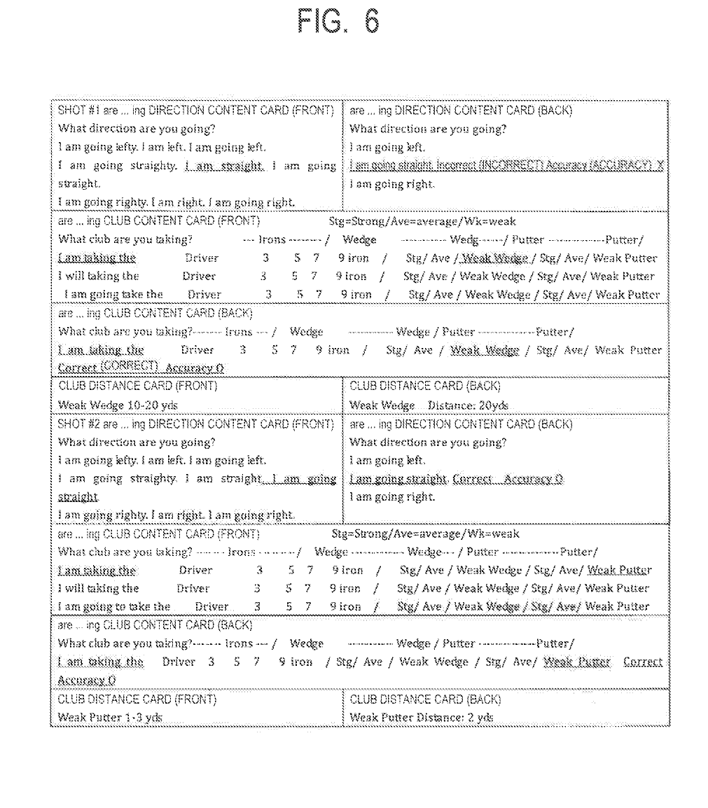

FIG. 6 exemplifies the language card selected at two shots #1 and #2 and a game progress situation. On the front of the direction content card at the first shot #1, a question “What direction are you going?” is illustrated, and a fact that an answer “I am straight.” was made is illustrated. The back of the direction content card illustrates that a correct answer is “I am going straight.” and the selected answer is wrong. On the front of the club content card at the first shot #1 illustrates that a question “what club are you taking?” was made and an answer “I am taking the Weak Wedge” was made. The back of the club content card illustrates that the answer is correct. On the back of the club distance card at the first shot #1 describes “Weak Wedge Distance: 20 yds”, which illustrates that the ball distance of a weak wedge is 20 yards. In this way, at the first shot #1, it is determined that the ball flies straight for the carry of 20 yards.

For the second shot #2, too, the similar game progress state is exemplified. That is, the front of the direction content card at the second shot #2 illustrates that a question “What direction are you going?” was made, and an answer “I am going straight.” was made. The back of the direction content card illustrates that the correct answer is “I am going straight.” and the selected answer is correct. The front of the club distance card at the second shot #2 illustrates that a question “What club are you taking?” is made and an answer “I am taking the Week Putter.” was made. The back of the club content card illustrates that the answer is correct. The back of the club content card at the second shot #2 describes that “Weak Putter Distance 2 yds” and illustrates that the carry of the weak putter is 2 yards. In this way, at the second shot #2, it is determined that the ball flies straight for the carry of 2 yards.

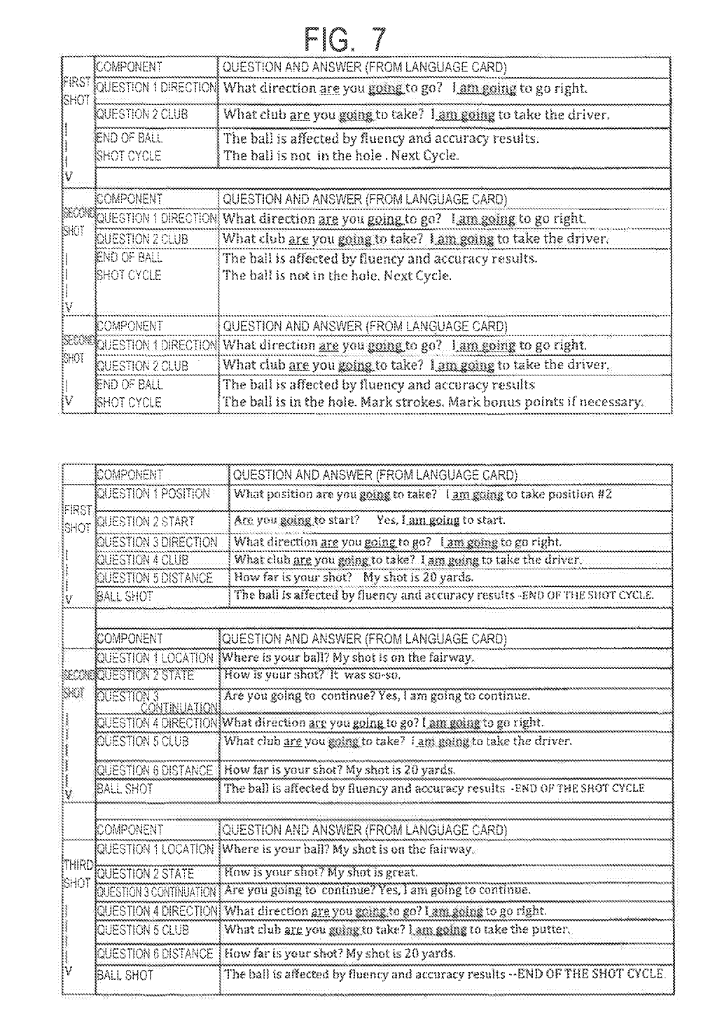

On an upper side in FIG. 7, a conversation using the direction content card “What direction are you going to go?”, “I am going to go right.” and a conversation using the club content card “what club are you going to take?”, “I am going to take the driver.” are shown. On a lower side in FIG. 7, types of cards are added, and an example in which conversations on a position, start, location, a state, continuation or not and a ball distance is carried out is shown. As a conversation on the position, “What position are you going to take?”, “I am going to take position #2.” are shown. As a conversation on the start, “Are you going to start?”, “Yes, I am going to start.” are shown. As a conversation on the location, “Where is your ball?”, “My shot is on the fairway.” are shown. As a conversation on the state, “How is your shot?”, “It was so-so.” are shown. As a conversation on whether or not to continue, “Are you going to continue?”, “Yes, I am going to continue.” are shown. As a conversation on the carry, “How far is your shot?”, “My shot is 20 yards.” are shown.

There are various other conversations on start. For example, if the present invention is applied to a baseball game, the game may be started by an expression “Are you going to pitch/hit? Moreover, if the learner's intention to start is clear, the game can be started by an expression “Are you going to start?” or an expression “Will you move?” Furthermore, the game may be started by a general expression “What are you going to do?”

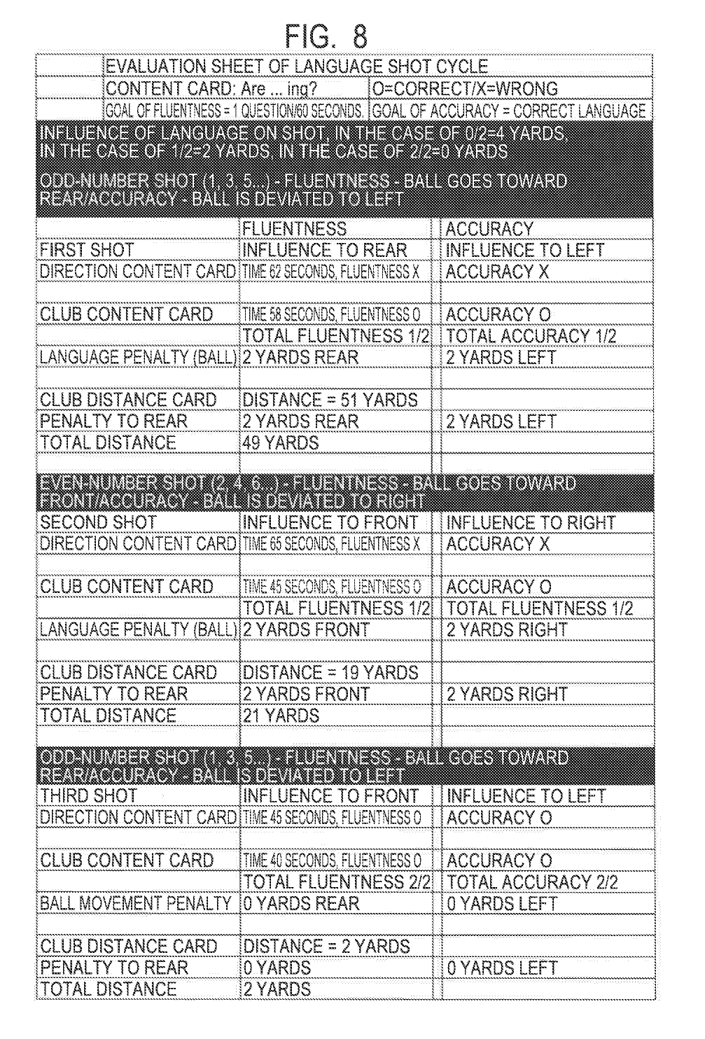

FIG. 8 exemplifies an evaluation sheet. This evaluation sheet applies a change to the direction and the carry of the ball determined in accordance with each language card based on each evaluation result in the conversation process and gives an influence on them. This evaluation sheet is used when the position of the piece is determined at Step S109 in FIG. 5, for example.

In the answer, the fluentness and accuracy are evaluated as linguistic evaluation items. To answer to one question within 60 seconds is considered to be a goal of the fluentness. Moreover, to be correct in terms of widely used customary expressions, idioms, the grammar and the like is considered to be a goal of accuracy. Moreover, proficiency to use polite expression or euphemism with “would”, “could”, “might” and the like may be also evaluated.

At an odd numbered shot, a change is added so that the ball is moved rearward due to a low evaluation of the fluentness. Moreover, a change is added so that the ball is moved to the left by the low evaluation of accuracy. At an even numbered shot, a change is added so that the ball goes to the front by the low evaluation of the fluentness. Moreover, a change is added so that the ball is moved to the right by the low evaluation of accuracy.

Specifically, in two types of the conversation by the direction content card and the club content card, if an “X” mark representing rejection is given twice to the fluentness, the ball is moved to the front or to the rear only by 4 yards as a penalty. Moreover, if the “X” mark representing rejection is given once to the fluentness, the ball is moved to the front or to the rear only by 2 yards as a penalty.

In two types of the conversation by the direction content card and the club content card, if the “X” mark representing rejection is given twice to the accuracy, the ball is moved to the right or to the left only by 4 yards as a penalty. Moreover, if the “X” mark representing rejection is given once to the accuracy, the ball is moved to the right or to the left only by 2 yards as a penalty.

If there is no “X” mark representing rejection for either of the fluentness and the accuracy, the direction and the ball distance of the ball determined based on the conversation according to each language card are not changed.

For example, at the first shot, the learner requires 62 seconds to answer according to the direction content card. Since this is longer than the goal of 60 seconds, the evaluation of fluentness is the “X” mark as rejection. Moreover, the learner is given the evaluation of the “X” mark as rejection for the answer according to the direction content card. Furthermore, the learner requires 58 seconds for the answer according to the club content card. Since this is not longer than the goal of 60 seconds, the evaluation of the fluentness is an “O” mark as passing. Moreover, the learner is given the evaluation of the “O” mark as passing for the answer according to the club content card.

Therefore, there is one rejection for the fluentness, and the ball is moved to the rear only by 2 yards. The carry of the ball determined based on the conversation according to each language card should have been 51 yards, but the movement to the rear by the 2 yards makes 49 yards. There is one rejection for the accuracy, and the ball is moved to the left only by 2 yards.

At the second shot, the learner requires 65 seconds to answer according to the direction content card. Since this is longer than the goal of 60 seconds, the evaluation of fluentness is the “X” mark as rejection. Moreover, the learner is given the evaluation of the “X” mark as rejection for the answer according to the direction content card. Furthermore, the learner requires 45 seconds for the answer according to the club content card. Since this is not longer than the goal of 60 seconds, the evaluation of the fluentness is the “O” mark as passing. Moreover, the learner is given the evaluation of the “O” mark as passing for the answer according to the club content card.

Therefore, there is one rejection for the fluentness, and the ball is moved to the front only by 2 yards. The carry of the ball determined based on the conversation according to each language card should have been 19 yards, but the movement to the front by the 2 yards makes 21 yards. There is one rejection for the accuracy, and the ball is moved to the right only by 2 yards.

At the third shot, the learner requires 45 seconds to answer according to the direction content card. Since this is not longer than the goal of 60 seconds, the evaluation of the fluentness is the “O” mark as passing. Moreover, the learner is given the evaluation of the “O” mark as passing for the answer according to the direction content card. Furthermore, the learner requires 40 seconds for the answer according to the club content card. Since this is not longer than the goal of 60 seconds, the evaluation of the fluentness is the “O” mark as passing. Moreover, the learner is given the evaluation of the “O” mark as passing for the answer according to the club content card.

Therefore, since there is no rejection “X” for either of the fluentness and the accuracy, the direction and the carry of the ball determined in accordance with each language card are not changed. The carry of the ball determined in accordance with each language card is 2 yards, and the game is proceeded with as it is.

As described above, the direction and the carry of the ball are determined in accordance with the evaluation on the answer by the learner in the game, and the evaluation of the answer by the learner can give an advantageous or disadvantageous influence to the learner. It is not necessary to reflect all the evaluations in the ball direction or carry. For example, at least either one of the fluentness (quickness and smoothness) and the accuracy may be reflected in the ball direction or carry. Moreover, the evaluation on the answer may be reflected in the ball direction or carry only for the odd-numbers shots, the odd-numbered shots or each shot.

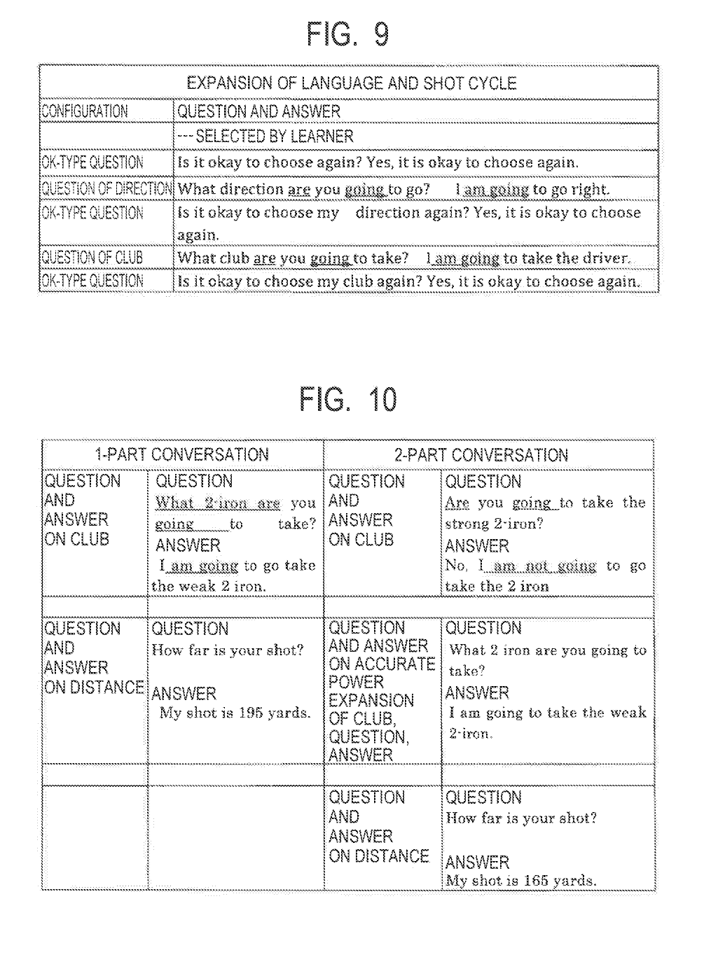

FIG. 9 illustrates a flow of the conversations when an OK question card is added to the direction content card and the club content card. The OK question cards determines a conversation for re-selection of the direction content card or the club content card between the learner and the teacher or between the learner and the foreign language practice device. The OK question card is selected after the direction content card or after the club content card. On the front of the OK question card, an English sentence for checking the selection by the learner of the language card is described such that “Is it okay to choose my direction again?” On the back of the OK question card, an English sentence answered by the teacher or the foreign language practice device on the check contents is described such that “Yes, it is okay to choose again.”

In the above, the example in which the cards are selected in the order of the direction content card, the club contents and club distance cards was described. Each language card may be divided into a plurality of questions and answers. FIG. 10 illustrates an example in which, in comparison to a 1-part conversation based on the one type of the club content card, a 2-part conversation by the two types of the club content cards are carried out. In this example, the club content card is divided into two types, and the 2-part conversation is carried out by the two types of the club content cards. In the game, the bundle of the first type of the club content cards and the bundle of the second type of the club content cards are provided.

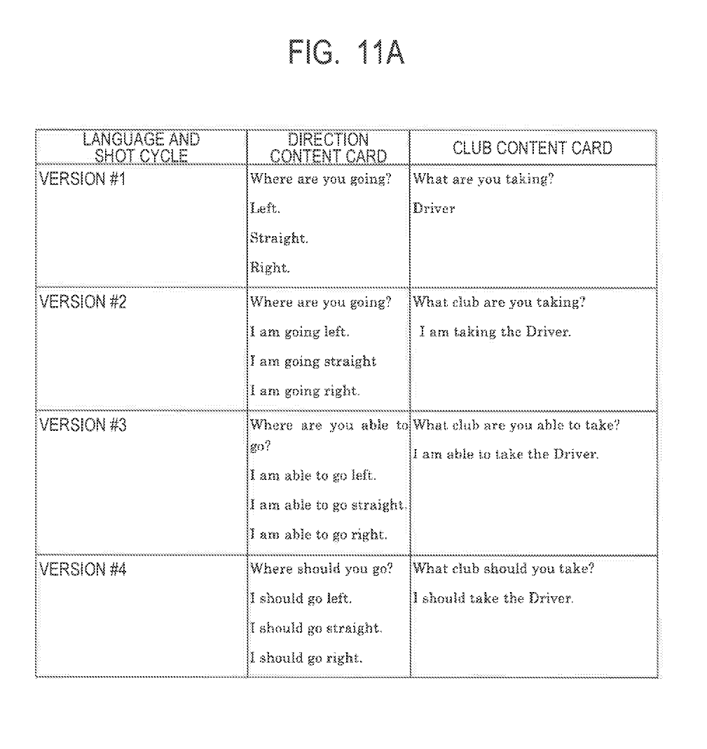

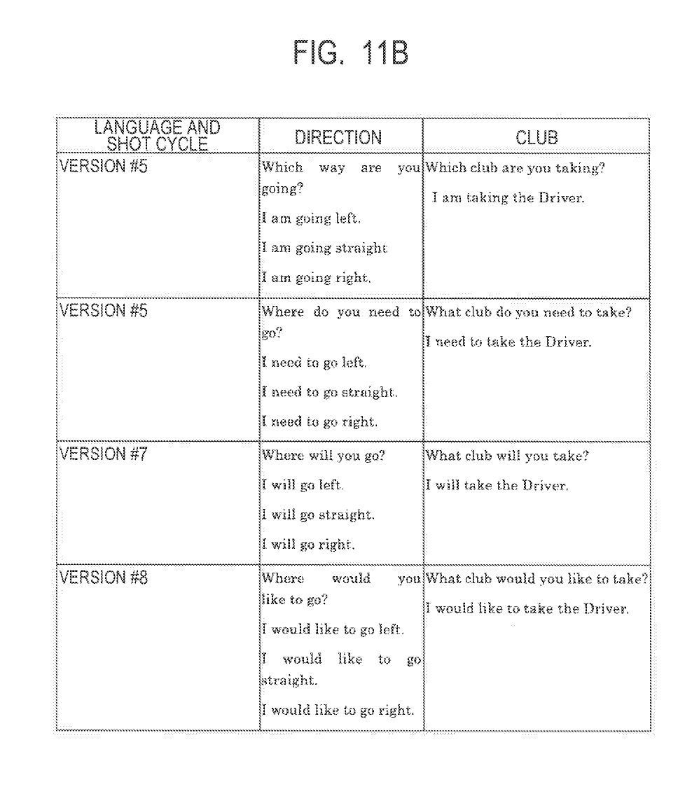

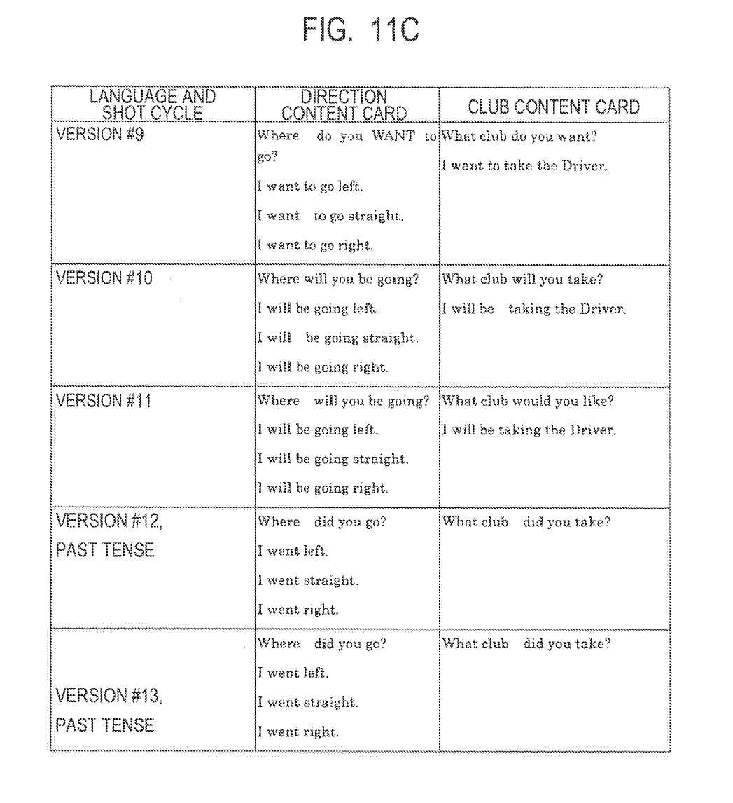

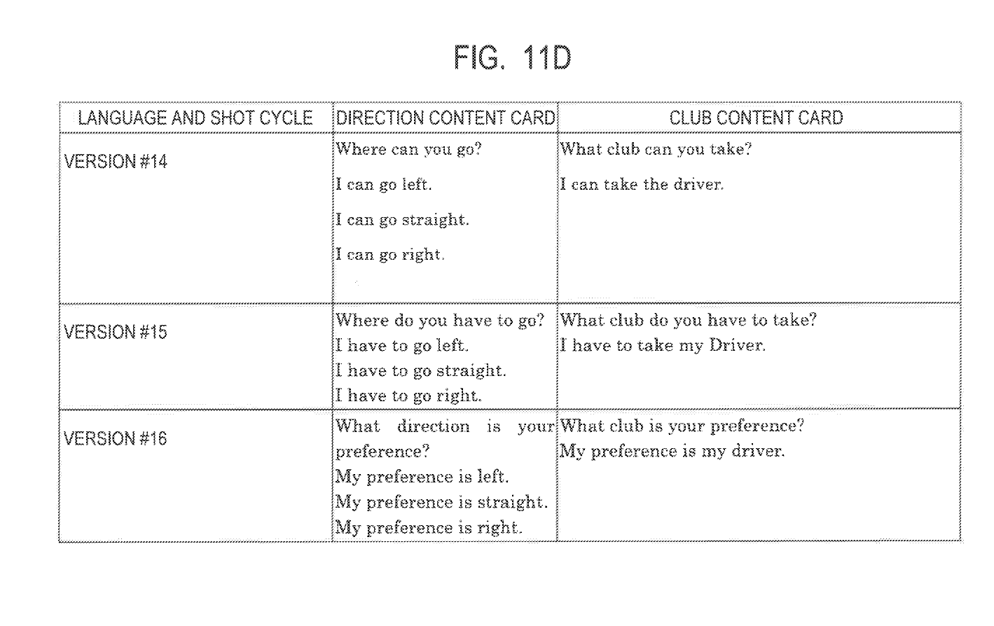

In FIGS. 11A, 11B, 11C, and 11D, a plurality of questions illustrated by the direction content card and the club content card are illustrated as a version #1 to a version #16.

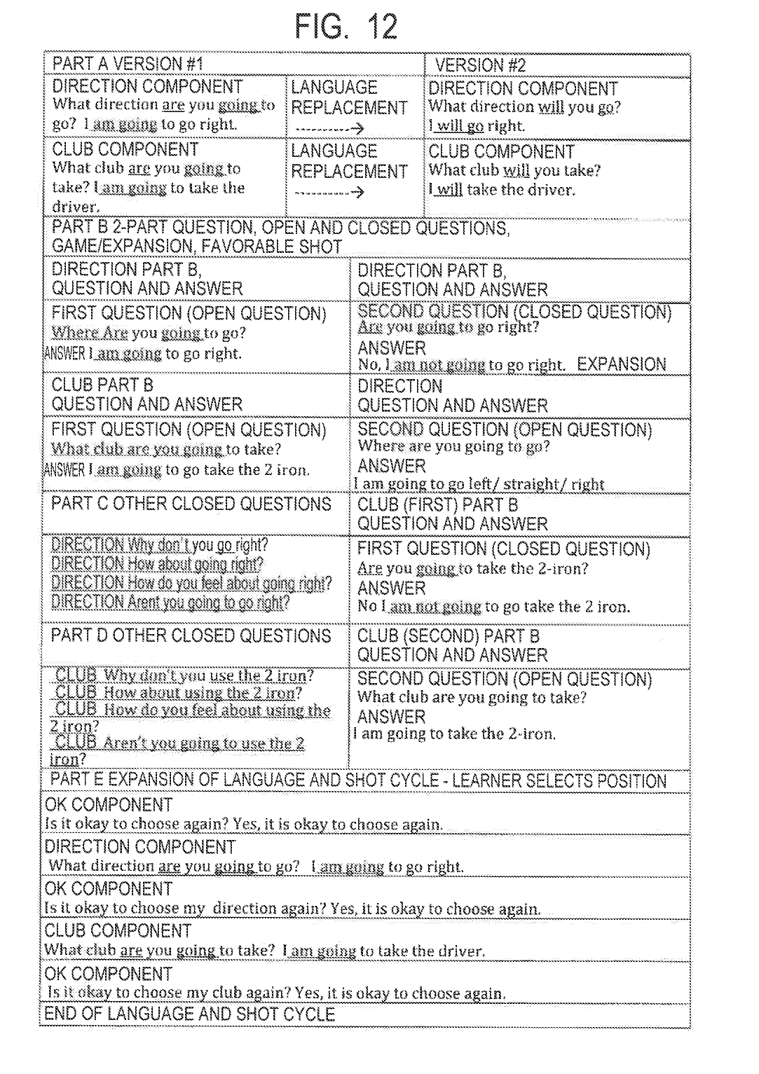

FIG. 12 illustrates a replacement probability of the question. The question or answer described on a right-side column (Version #2) is obtained by expanding and replacing the question or answer described on a left-side column (Version #1). For example, a question using “be going to” can be replaced by a question using “will”. Part A illustrates language replacement of a direction component and a club component. By means of the language replacement, “V+ING” is replaced by “V+WILL”. Part B illustrates the expansion of the component. The expansion includes two types of questions in the component. The two types of questions are a closed question (answered by yes or no) and an open question (plural answers). This expands the language and shot cycle. The language replacement can be used also for a 2-part question. The language replacement can be further used for question in a 3-part constitution in the component. A question of proposal, that is, Part C illustrates a special question type in the direction component. A question of proposal, that is, Part D illustrates a special question type in the club component. In Part E, the language and the shot cycle become longer. For the direction or the club re-selected after returning, the language and the shot cycle are made longer.

Other questions or answers obtained by the replacement shown in FIG. 12 are stored in the storage portion 28 and give variations of the conversation. When the learner makes an answer, if the answer is within a range of replacement of one answer, the answer is recognized to be correct. For example, even if the learner answers with the word “will” to a question using “be going to”, it is recognized as a correct answer in the foreign language practice device.

Moreover, when the game is repeatedly played, the learner remembers the questions and the answer options in each card in some cases. In order to handle such a case, the foreign language practice device may be constituted such that in the direction content card and the club content card, options of original correct expressions can be replaced by options of wrong expressions or the options of wrong expressions are added. In this case, description contents of each card stored in the storage portion 28 are changed by the operation of the operation portion 10. Moreover, if each card is formed by actual paper, plastic or the like, the descriptions on the cards may be rewritten so that the options of original correct expressions can be replaced by options of wrong expressions or the options of wrong expressions are added.

Furthermore, the foreign language practice device may change a degree of difficulty of the questions illustrated by the direction content card and the club content card in accordance with the evaluation of the answer. For example, if the evaluation of the answer by the learner is good, the degree of difficulty of the question shown subsequently by the direction content card and the club content card may be made higher. On the other hand, if the evaluation of the answer by the learner is not good, the degree of difficulty of the question shown subsequently by the direction content card and the club content card may be made lower.

The contents in each language card for proceeding with the question and the conversation shown in FIGS. 9 to 12 are stored as a database in the storage portion 28.

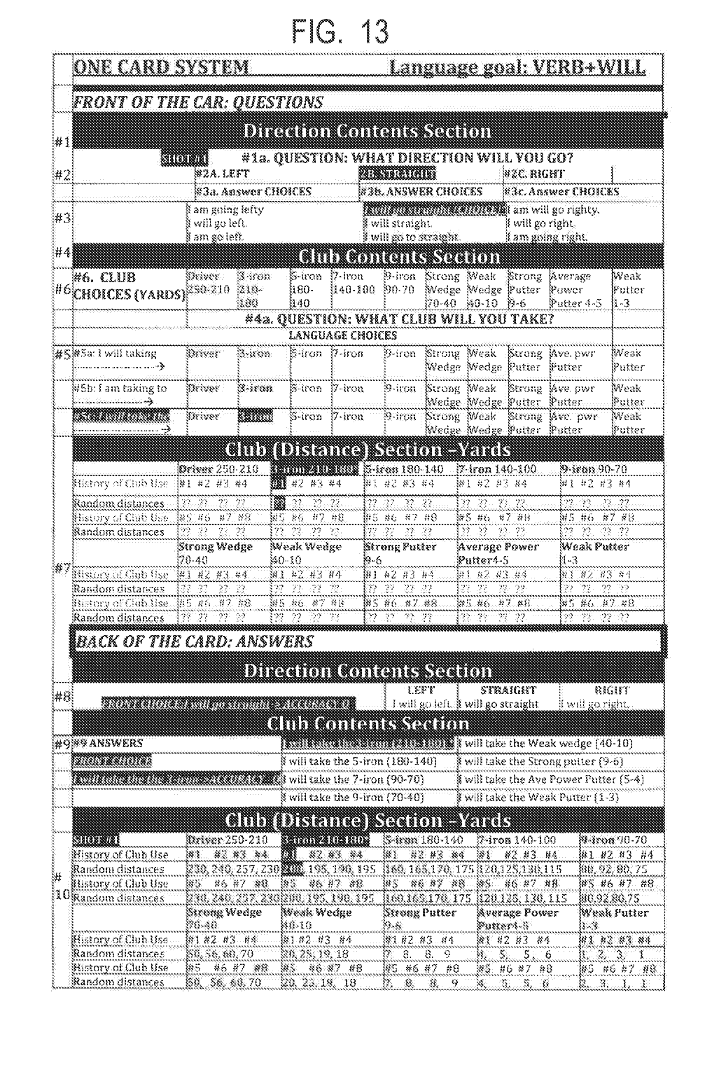

FIG. 13 illustrates an example of a complex card used in a one-card type game. The complex card may be formed by paper, plastic or the like or may be displayed on the display portion 16 of the foreign language practice device. The complex card integrates the aforementioned direction content card, the club content card, and the club distance card in one card.

The complex card includes a direction content section, a club content section, and a club (distance) section. Columns #1 to #7 are described on a front of the complex card, while columns #8 to #10 are described on a back of the complex card.

In the column #1, a question “What direction will you go?” is illustrated. In the column #2 in the direction content section, “2A. LEFT”, “2B. STRAIGHT”, “2C. RIGHT” are illustrated as options of the direction. In the column #3, answer options for each direction are illustrated. FIG. 13 illustrates that “2B. STRAIGHT” was selected and moreover, “I will go straight.” was selected.

On the column #4a in the club contents, a question “What club will you take?” is illustrated. Moreover, as three answer options when the club is to be selected, “#5a: I will taking . . . ”, “#5b: I am taking to . . . ”, and “#5c: I will take the . . . ” are illustrated. Furthermore, 10 types of club options are illustrated to each answer. FIG. 13 illustrates that “#5c: I will take the . . . ” was selected as an answer, and moreover, the No. 3 iron “3-iron” was selected as a club.

In the column #7, the club (distance) section is illustrated. In each of columns for the 10 types of clubs, symbols “#1” to “#8” are illustrated, and it is shown that the ball distance can be determined for each of the first to eighth shots. However, in the club (distance) section in the column #7, the symbols “??” are given as the carry in each column, and it is shown that the club (distance) section in the column #10 illustrated on the back surface should be referred to.

In the column #8, the correct answers for the questions in the direction content section are illustrated. That is, accurate answers for each of “LEFT”, “STRAIGHT” and “RIGHT” are illustrated. Moreover, “ACCURACY 0” is illustrated to the answer “I will go straight” made on the front surface, and it is shown that the answer was correct.

In the column #9, the correct answers for the questions in the club content section are illustrated. That is, correct answers for each of the 10 types of clubs are illustrated. Moreover, “ACCURACY 0” is illustrated to the answer “I will take the 3-iron” made on the front surface, and it is shown that the answer was correct.

In the column #10, the club (distance) section is illustrated. The symbols “#1” to “#8” are illustrated in each of the columns for the 10 types of clubs, and the carry for each of the first to eighth shots is shown, respectively. In this figure, it is shown that the carry at the first shot using the No. 3 iron is 200 yards. Moreover, for example, it is shown that the carry at the third shot using No. 7 iron is 130 yards, and the carry at the sixth shot using the strong wedge is 56 yards.

In the conversation process using the complex card, the club, the direction and carry of the ball used at each shot are determined. Moreover, the evaluation is made for the answer to the learner.

Moreover, if the complex card is shown by the foreign language practice device, each carry described in the club (distance) section in the column #10 may be set in advance at random by the foreign language practice device. Moreover, in either cases where the complex card is formed by paper, plastic or the like or where it is shown by the foreign language practice device, each carry may be determined in advance at random by the teacher or the learner.

In the one-card type game, the ball distance of the ball is determined at random. Thus, the progress state of the game is diversified, the game becomes more attractive for the learner, and moreover, learning motivation of the learner is increased.

The complex cards may be divided into three kinds of cards. For example, it may be so configured that the direction content section is described on the front and back of a first card, the club content section is described on the front and back of a second card, and the club (distance) section is described on the front and back of a third card. Moreover, the complex cards may be divided into two kinds of cards. For example, it may be so configured that the direction content section and the club content section are described on the front and back of the first card, and the club (distance) section is described on the front and back of the second card.

According to the foreign language practice device according to this embodiment, an opportunity of intuitive communication without a translation in mind can be provided to a learner. Moreover, an opportunity of active or passive communication according to a situation can be provided to a learner. Furthermore, while an inappropriate expression is pointed out and an opportunity of repetitious practice and the like is provided to the learner, an opportunity of enjoyable and efficient foreign language practice can be given to the learner. Moreover, foreign language learning can be further simplified. As a result, the learner can maintain motivation to the foreign language learning and can learn competency of natural and quick communication.

In the above, the embodiment of practicing conversation has been described. The foreign language practice device according to this embodiment may be used also for practice of reading/writing. In this case, the question by the language card is displayed on the display portion 16, and the learner answers by inputting characters from the operation portion 10. The practice of conversation or reading/writing may relate to other subjects such as mathematics, physics and the like. Moreover, the present invention may be used as a measure for a standardized test examining linguistic competence such as TOEIC (registered trademark).

Moreover, the present invention can be used for learning of a foreign language other than English. Furthermore, a child who has not sufficiently learned the native language may use it for learning of the native language.

Moreover, each language card, the game field 36, the evaluation sheet 40 and the like displayed on the display portion 16 may be a real language teaching material printed on a sheet-like printed medium such as paper, plastic and the like. In this case, a role of the foreign language practice device is played by a teacher who is a human being. The question displayed on the language card does not have to be a complete sentence but may be information for the teacher to identify the question determined in advance. That is, the question displayed on the language card may be an abridged sentence, a symbol, a sign, a figure, a color and the like that the teacher can recognize what question should be asked. Moreover, by allowing the learner and the teacher to remember a part of the conversation in advance, the sentence described on the language card may be omitted as appropriate. In this case, it may be so configured that required minimum abridged sentence, symbol, sign, figure, color and the like are described on the language card so that the learner and the teacher proceed with the conversation.

### Embodiment 1

In the following, the embodiment of the present invention will be described in detail. The foreign language practice device according to the embodiment of the present invention is a language device which can be incorporated in many games for teaching, learning, reviewing, using, testing, remunerating for, and enjoying facts and concepts of a language. This device can be used by a student learning a foreign language or a child learning the native language.

### 1. Current Situation of Art

For a long time of teaching English to people whose native language is not English (more than 30,000 classes), the inventor has observed that the students found difficulty in learning language or grammatical principles and facts. That is because proficiency requires a lot of tiresome language repetition. In order to overcome the language repetition, this device incorporates the language repetition in a game. As attentions of many scholars and documents are drawn, to learn by playing a game is an excellent and effective method.

### 2. Prior Art

Through patent searches by the inventor, there was no direct matching or similar concepts. In order to protect the invention in the present application, the inventor illustrates how excellent this device is as compared with the other systems in which language learning is incorporated in a game in terms of methodology of the prior art and an aspect of a game.

### (1) Language Learning Incorporated in Game—Methodology of Prior Art

Concerning the language learning and a game, the following indicates that the inventor's language learning methodology is more excellent than the other language learning systems.

U.S. Pat. No. 5,458,338 has a learning structure, a card, and a marker but that is inferior to the invention of the present application in application of a new language in a conversation or a real life and is lacking in a game aspect of giving motivation. U.S. Pat. No. 6,076,828 uses a card and develops a language skill, but students return to language translation and fluentness is sacrificed. U.S. Pat. No. 5,458,338 does not have an aspect of structured conversation. The lack of structure makes understanding of a new language non-intuitive and acquisition of the new language ineffective. Games such as U.S. Pat. No. 7,604,236 and U.S. Pat. No. 4,890,844 give only passive knowledge of words to students. U.S. Pat. No. 7,604,236 only identifies and matches a word or a phase with a card and a board game, and students are not allowed to actively use the new language.

### (2) Language Learning Incorporated in Game—Game Aspect of Prior Art

Concerning the language learning and games, the following tests and indicates how excellent the game aspect of the invention in the present application is as compared with the other systems.

U.S. Pat. No. 7,604,236 is a card game and its play is predictable and is different from the device according to the invention in the present application in which the language controls the ball by accuracy and fluentness and the result influences the game play. In U.S. Pat. No. 6,341,958, the learner can automatically switch off necessity of translation and explanation as in the device of the inventor, but there is no game play. Square Enix in U.S. Pat. No. 7,591,721 is a patent of a video game and is not a language. Square Enix uses “a video game which applies a predetermined rule to a game progress and imposes a penalty in case of a rule violation”. This language system imposes a penalty on a bad game play as in Square Enix but this language system also applies a penalty on use of a bad language. Similarly, a language result influences a shot and also influences control of the shot. In terms of the video game, it seems that a video game console or a controller short-circuits or works better for the language result. This unique and seamless incorporation makes separation between the language learning and the game impossible and its uniqueness also increases motivation for learning. U.S. Pat. No. 4,171,816 identifies a type of the grammar, language concepts, and utterance parts but unlike this device, they are not used actively for utterance or progress of the game. Other trials in Englishtown and Rosetta Stone lack in consistent structure such as a language and shot cycle. Moreover, the system is not constructed on the game and thus, the learner's motivation given for continuation of the learning is lowered. U.S. Pat. No, 4,890,844 uses a card in a game and only tests accuracy of the language in a memory game, and motivation given to the learner is far lower than playing golf. An art described in pending U.S. Application Publication No. US2007/0015121A1 uses a character and requires achievement of a goal through communication between the language and the virtual characters. On the contrary, this language device has a player profile having a given profile such as an age, power, clothes, money, and energy. As the game progresses, these characters change and influence the game play directly or indirectly.

### 3. What to Overcome

For a long time during which the inventor has been a teacher of a language conversation, the inventor observed that language learners had difficulties as follows in foreign language learning.

When a learner uses a foreign language, a system which is not to translate to the native language or from the native language is needed. Such a system that enables repetition of the language is needed. Such a system that the student does not translate in mind is needed by prompting the learner to answer quickly. Such a system that requires passive and active use of the language is needed. Such a system of intuitive language learning is needed. Such a system that increases vocabulary of the learner by language replacement is needed. Such a system that gives that immediate feedback to the learner is required is needed. Such a system that reviews the language learned before and further progresses it is needed. Such a system that takes in the above and makes learning enjoyable is needed.

### 4. Major Object

A goal of the device is to stimulate the language learning through a game such as golf, other sports games or a role playing game. The language is used in a language and shot cycle made of a speaking component. Each component uses the new language in a question and an answer and is measured in terms of accuracy and fluentness. The component is used for controlling the game, and the language result of the component influences the game or control of the game and thus, increases motivation of the language learner. Furthermore, a label in the device makes the learning intuitive and makes the learning enjoyable.

### 5. Advantageous Effect

Since the device is intuitive, the device shows how the language influences the game, its score, and the life and thus, students are further given motivation to learn the language. Since the language result influences the game play, fluentness and accuracy are improved. Since the structure requires proficiency in both passive and active knowledge of the student, they are increased. The students can use the new language in questions and answers. The structure and the label increase the knowledge and use of the language as follows. That is, what words should be used, how they should be used, when they should be used, why we use them, and where they should be used. The immediate language feedback and the repeated game play make the students to speak with more confidence. The learner can understand the language pattern from the labeling, which enables replaced language of the language. Since there are a pressure and realization of the fluentness, language translation with the native language is decreased. The teacher gives motivation and owns a new tool for teaching a language.

### 6. Major Steps to be Used

A golf grid (lattice) is created by boxes overlapped on the golf course so that the student can mark the shot. In order to mark the shot and to count the score after playing the hole is finished, a circular marker is used. A shot arrow is used for selecting a direction on the golf surface. The content card (language card) is used, the ball is moved, and movement of the student from start to end of playing the hole is supported. In order to measure achievement of the goal of fluentness by the student, a timer is used.

The language to be learned is selected from the content card. The content card is made so that the student can understand how the question and the answer are made by the new language in the language and shot cycle. A language result record chart indicates that the language result (in terms of accuracy and fluentness) influences the shot.

### 7. Practice Using Foreign Language Practice Device

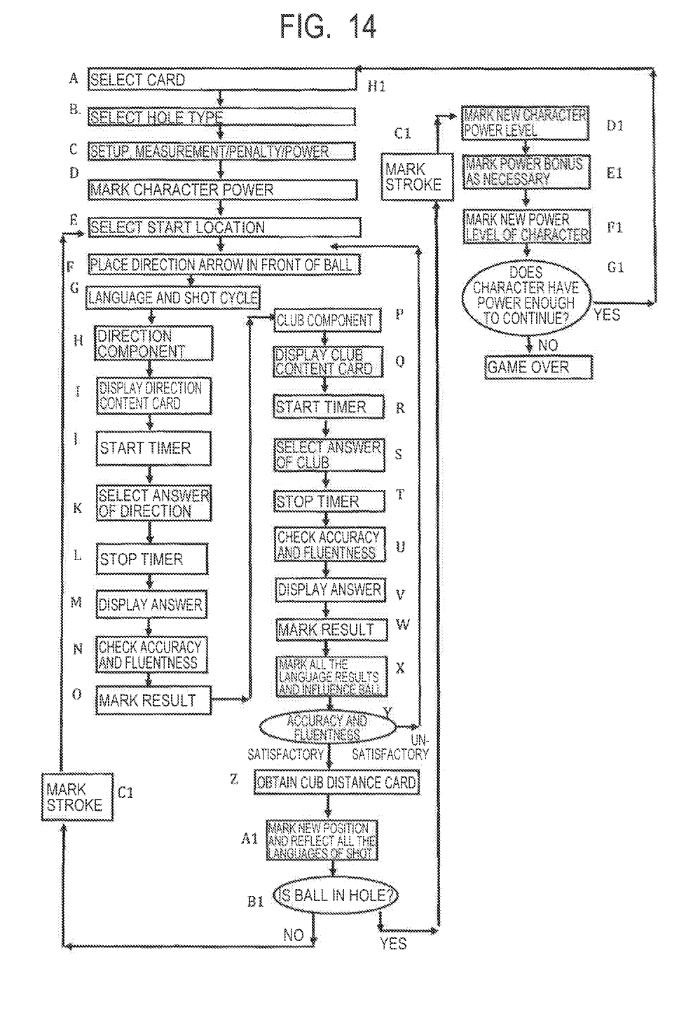

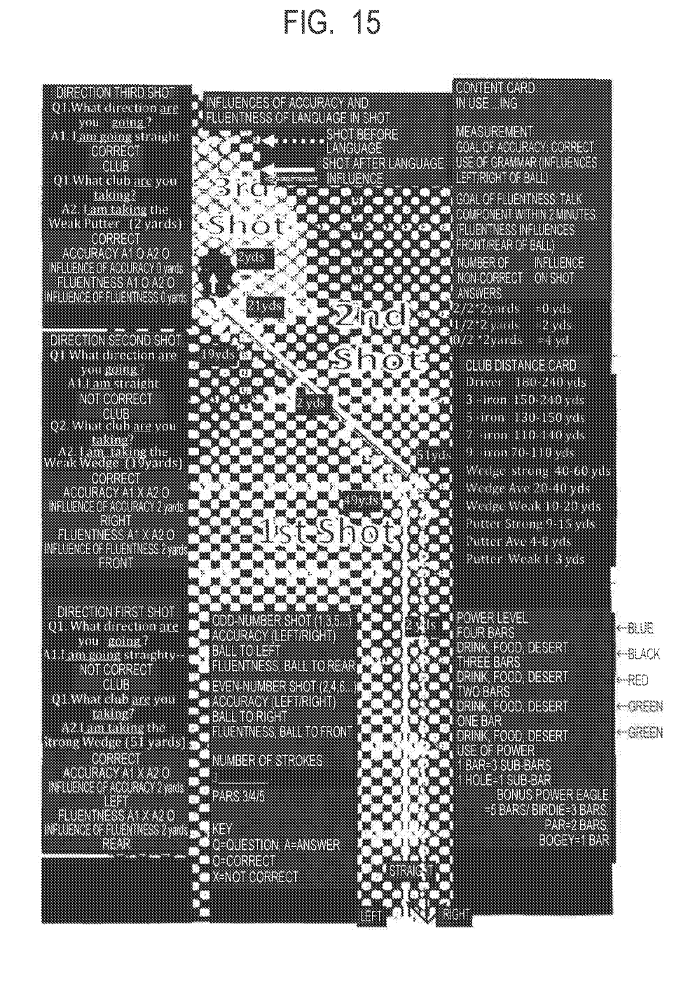

The core of this device is the language and shot cycle as illustrated in FIG. 14. The language and shot cycle incorporates the language practice in golf. The language and shot cycle has a language goal (defined by the label) and is made of components composed in a pattern for carrying out a conversation relating to golf. Since the label defines the component, it is easy to introduce the language and to replace it. In each component, the language is used for forming a question and an answer, and the result is measured in terms of accuracy and fluentness, and the results influence the shot. Lastly, the number of components can be expanded or reduced.

### (1) Analog Language and Shot Cycle—Golf Flowchart (FIG. 14)

FIG. 14 illustrates how the language controls (proceeds with) the game. The game is influenced by the language. And it illustrates how an environment gives motivation relating to good use of a language. The learner uses this device from start of the game (a shot place of the first shot) and advances the ball until the game ends (the ball is in the hole).

A. “Select card”—The content card is a unique method of expressing a component and each content card has a large number of content cards. The type and the number of the content cards are selected based on language needs of the learner.

B. “Select hole type”—The selected hole type is based on the language needs of the learner. Each hole has various variables influencing the vocabulary and the grammar.

C. “Setup”—The measurement determines how the language is measured (accuracy and fluentness) and penalties. The language penalty determines how the language result influences the ball. A power amount determines a play environment (start power, power usage, and play remuneration). Adjustment of these variables influences the learning environment.

D. “Mark character power”—The learner marks its start power level and a money level.

E. “Select start location”—The learner selects a start location on the course, marks it and moves the marker to the start location.

F. “Place direction arrow in front of ball”—A direction arrow is placed in front of the ball indicating three direction options: left, straight, right from each ball position.

G. “Language and shot cycle” is made of direction and club components. This indicates a goal of the subsequent speaking sequence and also indicates a repetitious speaking pattern.

H. “Direction component”—The question and answer relating to the direction determine the direction of the ball. The language is provided by the content card.

I. “Display direction content card”—The direction content card is displayed near the learner. The learner sees the question and answer.

J. “Start timer”—The timer is started. Measurement of fluentness is started.

K. “Select answer of direction”—The learner selects an answer.

L. “Stop timer”—The timer is stopped, and the time is recorded.

M. “Display answer”—The direction content card is turned over, and the answer is displayed.

N. “Check accuracy and fluentness”—Concerning the accuracy, the answer is checked with respect to the back surface of the language card. Concerning the fluentness, the recorded time is checked with respect to the goal of the fluentness, and the result is recorded on the evaluation sheet.

O. “Mark the result”—The result of the direction component is recorded. Concerning the accuracy and the fluentness, O means that the answer was satisfactory, while X indicates that the answer is not satisfactory (FIG. 8).

P. “Club component”—The question and answer relating to the club using the content card determines the distance of the ball.

Q. “Display club content card”—The direction content card is displayed near the learner. The learner sees the question and answer.

R. “Start timer”—The timer is started. The measurement of the fluentness is started.

S. “Select answer of club”—The learner selects the answer and the club.

T. “Stop timer”—The timer is stopped, and the time is recorded.

U. “Check accuracy and fluentness”—Concerning the accuracy, the answer is checked with respect to the back surface of the language card. Concerning the fluentness, the recorded time is checked with respect to the goal of the fluentness, and the result is recorded on the evaluation sheet exemplified in FIG. 8.

V. “Display answer”—The club content card is turned over, and the answer is displayed.

W. “Mark the result”—The result of the direction component is recorded.

X. “Mark all the language results and influence ball”—The results of the direction and club components are added. The both influence the shot.

Y. “Is accuracy/fluentness satisfactory?”—The language result is measured with respect to the goal set in “setup”. If the language goal is not achieved, the learner carries out the language cycle again.

Z. “Take club distance card”—After the language goal is achieved, the club distance card (the same club as the club language component) is taken and turned upside down concerning the shot distance.

A1. Mark the new position and influence of all the languages with respect to the shot. The ball is moved to the new position, the language result (penalty) is applied to the shot, and the ball is moved in accordance with the rule determined in advance as shown in FIG. 8.

B1. “Is boll in hole?”—If the ball is not in the hole, the learner returns to F and repeats the language and shot cycle until he/she finishes the cycle. If the ball is in the hole, the language and shot cycle is finished, and the hole is also finished.

C1. “Mark stroke on card of learner”—The number of strokes to finish the hole is recorded.

D1. “Mark new character power level”—Indicates the power amount used at the hole. Power use rule: 3 holes=1 bar, 9 holes=3 bars, 1 hole=1 sub-bar.

E1. “Mark power bonus”—If the player is given a good score in compliance with the golf rule, the learner gains a power bonus. Eagle=4 power bars, birdie=3 power bars, Par=2 power bars, bogey=1 power bar.

F1. “Mark new power level of character”—The power level is changed after the bonus power bonus is added.

G1. “Does character have power enough for continuation?”—If the learner does not have sufficient power, the game is finished.

H1. “Select content card” indicates start of a new hole. This point is the same as the A point.

### (2) Language Option for Speaking Structure and Ball Control (FIGS. 4A to 4C)

The content card enables control of language practice and shot by the direction component (direction control) and the club component (distance control). There are many various types of content cards by various methods expressing the components in terms of words, grammar, idioms, and phrases. The content card is a unique method of expressing the component, and each content card has a large number of content cards concerning the component. The large number of content cards tests a unique method expressing the component by using various multiple-choice cards. On the front surface of the content card, clear language is used for a question and three possible answers. The correct answer is on the back surface. In this embodiment, the language and shot cycle has two components, that is, the direction component and the club component. The direction component has a bundle of direction content cards. The club component has a bundle of club content cards and a bundle of the club distance cards.

The goal is to move the ball from the start to the end by using the smallest number of shots by using a club card option list for reference. In order to minimize the number of sets (decks) and play fields, the following 11 sets of club distance cards can be used: Three putter sets (weak power, average power, strong power), three wedge sets (weak power, average power, strong power), one No. 9 iron set, one No. 7 iron set, one No. 5 iron set, one No. 3 iron set, and one driver set.

(3) How to Use

First, on the direction content card, the language learner selects a direction option from (left, straight, right), selects a language answer from language multiple-choice answers, and checks the answer on the back surface of the (left, straight, right) options.

Subsequently, the learner selects one club from 11 club options on the club content card, selects one language answer from three multiple-choice answers, and checks the answer on the back surface.

Lastly, the learner selects the club distance card corresponding to the club selected on the club content card, turns it upside down so as to indicate the distance, and moves the ball in accordance with the card. The distance on the club distance card follows a standard deviation within a range of the card and other statistical rules. By using the statistical rules, the game is made more reliable, and the learner can enjoy the game play.

In order to minimize the number of card sets, the set of the club distance cards can be used by any type of club content card set. Concerning a specific language on the content card, at least four different versions of content cards, that is, four multiple-choice answer sets.

In another embodiment, the distance card set may be a complete golf club set, and concerning each club, there can be one or more power distances.

In another embodiment, the distance card may have one power distance as 150 yards, and the learner has an option of using a distance and an option of using percentage distance card for control. For example, it is assumed that 150 yards (30%)=45 yards. 150 yards (60%)=90 yards.

The power of a shot may be determined by a conversation as follows. “What club are you using?”, “I am using a 3-iron (180 to 200 yards).”, “How much power are you using?”, “I am using 80% (144 to 160 yards).

In another embodiment, the description contents of each of the club content card and the club distance card can be described on the same card.

In another embodiment, the computer can collect information of the club content card and the card distance card, and the database stores all the answers and checks the answers to the database immediately.

In another embodiment, another type of card having a distance such as between two points or in a role playing game can be used for moving the ball from the start to the end. In one case, the golf club can be replaced by food. For example, meat having a high power is for a long shot, and lettuce having a low power is for a short shot. In another case, the power shots may be determined from healthy food, and the weak power shot may be determined from junk food.

### (4) Assumed Practice Method

In one embodiment of a use method, the learner just observes the question and answer of the language and shot cycle, but the learner can yet play the game.

In one embodiment, the learner tests the knowledge by selecting one correct answer from many options and can play the game.

In one embodiment, the learner tests the knowledge by selecting two or more correct answers from many options and can play the game.

In another embodiment, the learner can read out the card and plays the game, not a test of the language.

In another embodiment, the learner can ask a question without seeing the card and practices the language and can play the game until he/she can answer. However, they can use the card to check the answer. They can do this by preparing blank language cards of the direction content card, the club content card, and the club distance card or they can do this simply by using the club distance card after the questions and answers relating to the direction and club components are practiced orally.

In one embodiment, the teacher performs the use of the content card. Later, the learner reproduces the performance, uses the content card in the language and shot cycle and also plays golf.

In one embodiment, the teacher performs the use method of the language in words and plays the game by the club distance card. Later, the learner reproduces the performance and simply uses the club distance card in the language and shot cycle and plays golf. The teacher supports the language as necessary.

In one embodiment, the program by the content card in the database performs the use method of the content card. Later, the learner reproduces the content card in the language and shot cycle and plays golf.

In another embodiment, the language learner selects a plurality of content cards relating to each component of the language and shot cycle. The learner can mix various languages relating to the component while expecting the induction of an error of another learner. In this case, the learner performs review as a game tool.

In another embodiment, the language learner fills in the blank in the new language in the content card, checks the answer on the back surface and also plays the game.

### (5) Language Test

Many possible methods which test excellence of the knowledge of the language of the learner are shown. In an embodiment of another use method using a computer, the learner can play a game and use the language in the question and answer by voice, a touch screen, typing or a mouse click or by using replacement of the question and answer in the network all over the world.

In another embodiment, means for testing may be finding of multiple choice, correct spelling or correct usage of phrases or removal of wrong phrases.

In another embodiment, other variables capable of measuring language pronunciation and appropriateness can also influence a shot.

In another embodiment, instead of use of a language in a component, a variable such as correctness of spelling, accuracy of honorific expressions or accuracy of use of the language may be a goal and can influence the shot.

In another embodiment, the language learner reads the question aloud, reads the answer aloud, fills in the blank in the new language in the content card, reads the answer on the back surface aloud, checks the answer and plays the game.

In another embodiment, the answer to the language card can be written on a blackboard or a whiteboard on the back of the player and be checked after selection of the answer.

### (6) Language and Shot Cycle (FIG. 7)—Important Tool in Incorporating Language Learning in Golf Play for Intuitive Learning and Repetitious Learning

The language and shot cycle is made of patterned language components. Each component has a defined label and a language goal. That is, the components are composed by patterns and promote conversation relating golf. The component is used, the ball is hit and controlled, and conversation is made on golf. Each component uses the language in the question and answer and tests the language from the language card. The results of the question and answer influence the accuracy and fluentness influencing the shots.

FIG. 7 illustrates two versions of the language and shot cycle. This is a cycle based on the direction component and the club component. An upper stage (short version) in FIG. 7 and a lower stage (long version) in FIG. 7 illustrate cycles of moving the ball from the start to the end by using the language.

The goal of the direction component is to talk about selection of a direction and to move the ball. The goal of the club component is to talk about selection of an appropriate club and to move the ball. To define the language goal of the component in advance enables the “direction”, “club”, and “distance” to visually lead to the game play and makes the learning intuitive. These language options navigate the game and play a role of a joystick or a game controller. A real physical joystick may be used for controlling the game. In this case, too, it may be so configured that an operation of the physical joystick is influenced by the evaluation to the learner.

In another embodiment, another language may be used as follows to control the game. How far are you hitting it?/I am hitting it a short distance/average distance/long distance. How much power are you going to use? I going to use a little power, I going to use an average amount of power, I am going to use a lot of power.

Since the system uses the game, and the game requires repetition in order to finish, the learner is given motivation to practice and to repeat. This is different from the other language learning system supporting a problem of translation between the native language and a new language of the learner.

In another embodiment, the component label can make learning further intuitive by using an intuitive symbol.

In another embodiment, the component label may be in the native language and may be changed to a foreign language after the learner gets used to the foreign language.

The lower stage in FIG. 7 is an embodiment different from the upper stage in FIG. 7. That expands the upper stage in FIG. 7 by expanding a possibility of another language relating to the language and shot cycle. An additional component of the language and shot cycle is as follows. A goal of the position component is to start the game by talking about selection of the position. A goal of a start component is to talk about starting of the game. A goal of a distance component is to talk about the distance of the ball as the result of selection of the club. A goal of a location component is to talk about where the location of the ball on the course is. A goal of a state component is to talk about what the shot should be. A goal of a continuation component is to talk about continuation or stop of the game.

The other components such as “position”, “start”, “continuation”, and “state” are similarly intuitive due to their natural order in the game play. The “position” component is located at the beginning, and many start options intuitively mean that the component goal is to select the position. The “start” component is located after the “position” and before the game play and thus, naturally gives the meaning of its “start” to the component. Similarly, English is used in international sports or games all over the world and the “start” is used at the beginning and therefore, the meaning is intuitive. The word “continue” is intuitive when the shot is finished and the play is not continued. To answer “Yes” or “No” to “continue”, the game is started or stopped and therefore, gives the meaning of the component. In another embodiment, “finished” is more intuitive than “continue” as the component label.

Alter a good or bad shot, the language learner or a gamer wants to talk about or express a feeling of the shot. Therefore, the “state” or a “feeling” component is intuitive in the game play after the shot. Moreover, to add a new component to the language and shot cycle should be done gradually so that the learner is not frustrated by too many languages.

In another embodiment, another component is added to the expanded language and shot cycle in the lower stage in FIG. 7. OK is the another component (FIG. 9). A language goal of the component “OK” is to request permission and to return to the previous component. If the idea of the learner is changed by the new component or after an error, the learner can navigate the game better. Therefore, the game is made further complicated but more interesting. The OK before the start component can be used as follows. Is it OK to start? The OK can be used after the direction component or the club component and changes the game play.

In another embodiment, in order to expand the language and shot cycle, a general language component such as “talk” is added and expands the language and shot cycle. A merit of this general label is that some language structures cannot be simplified into one phrase. To talk can be used to talk about the hole at the end of the language and shot cycle. Talk component: A distance from the ball to the hole is 180 yards, for example. No. 7 iron club range: 140 to 100 yards. Question: Is the shot too far for the No. 7 iron? Yes, it is too far for the No. 7 iron.

Moreover, at an arbitrary step in the shot cycle, general conversation (Talk label) may be inserted.

In another embodiment using the talk component, to talk can be used before each component with a goal of giving an advice relating to the direction: “Do you possibly want to go to the right?”

In the upper stage in FIG. 7, the language and shot cycle ends with the “club” and in the lower stage in FIG. 7, it ends with the “distance” since the shot is hit after the “distance” in the language and shot cycle. Since the language is used with the purpose of making a shot, the both are natural end of the cycle. After the shot, it is a climax of a game, and it is natural to finish the end of the game cycle and thus, to end the language and shot cycle.

In another embodiment, when the learner stops talking about the shot, the natural end of the cycle can occur, but it is “continuation” time and can be also used for an end point of the shot cycle.

In another embodiment, the language feedback can be made after each cycle, each hole or hole group.

In another embodiment, the language and shot cycle can be a tool for parents to teach a child who has just begun talking the first language in the native language.

In another embodiment, concerning the language and shot cycle, an object can be moved around the board by using a dice or another object having numerals instead.

In another embodiment, the language and shot cycle can be a software program and enables networks of learners all over the world to form a social work and the foreign language learners to connect to it and learn and play together. In the social network, a sponsor can fund their logo and the like used in the game field. Moreover, a question concerning the sponsor (using the language of the device) can be used in a profit model. The learner can earn points by answering the question concerning the sponsor as collaboration between the sponsor and the learner. For information of the sponsor, a game maker has another source of income.

In another embodiment, the problem of the language and shot cycle can be used to ask a question relating to the player, the club or the golf brand. Answers to these questions can be used for collecting marketing information relating to the brand.

In an application for a computer or a smartphone having a banner advertisement, the language from the content card can be used for negotiation with the banner advertisers or a game sponsor.

The banner advertisement on the application by the sponsor can be used in this device. The language used in this device can be used in various advertisements and banners. In another embodiment, the language and shot cycle can be used for navigating a monopoly type of a game.

In another embodiment, the language and shot cycle can be used for navigating between stages on the board. The language and shot cycle does not have to be used in an activity/operation screen of the game.

In another embodiment, the language and shot cycle can be used in a role playing game.

In another embodiment, the language and shot cycle can be used in a shooting game.

In another embodiment, if the distance or movement is the same at all times or if the game uses a constant motion such as Packman, the language and shot cycle may be only the “direction”. That is, in the language and shot cycle, at least either one of the moving direction and the distance of the piece is determined.

In another embodiment, after the language and shot cycle, each player draws a card from a set of “fight cards” and the players turn the cards upside down. It may be so configured that the player having the card showing the highest number wins the card, while the other players lose power. This may be use by a relative comparative language content card.

### (7) Expansion of Language and Shot Cycle: Replacement and Expansion of Language (FIG. 12)

Concerning the language and shot cycle (direction component and club component), there are a large number of language types (words, grammatical tenses or idioms or expressions) in each component. An upper part in FIG. 12 illustrates that language replacement is possible in the language and shot cycle but it is not limited to an example in FIG. 12. Since the meaning of the component is intuitive and the system enables easy replacement of phrases, the learners can increase their language knowledge quickly and easily as illustrated in the upper part in FIG. 12. Since many learners have a problem in increasing vocabulary in expressing the same thing, this system is extremely useful. The replacement effect can be used for the learners who need to increase the vocabulary quickly for tests such as TOEIC or TOEFL.

Each language may be replaced by support information such as labels (widely used symbols such as “!”, “?” and the like and signs), the native language of the learner, symbols expressing emotions (emoticons), intuitive symbols and the like. Moreover, each language may note such support information.

In one embodiment, many content cards can be used at the same time, and use of the various content cards can be used to deceive the other learners as a pitcher deceives a hitter by various kinds of pitching. By inserting a content card learned before by a current card, review can be made more interesting.

In another embodiment, the language and shot cycle can be expanded within the component as illustrated in the middle of FIG. 12 and can further challenge the learners as illustrated in the middle of FIG. 12.

### (8) Two-Part Question

In one embodiment, a first question can be designed to require a second question. For example, the “talk” component can be used together with the “club” component as follows. “Is it too far to use the No. 3 iron from here?”, “Yes, it is too far.”, “What club are you going to use?”, “I am going to use the No. 5 iron”. In another example, a two-part question can be used, and the game is made more accurate by three power options. Strong, average, and weak: What club do you want? I want the No. 4 iron card. Which No. 4 iron card do you want? I want a middle-strength card.

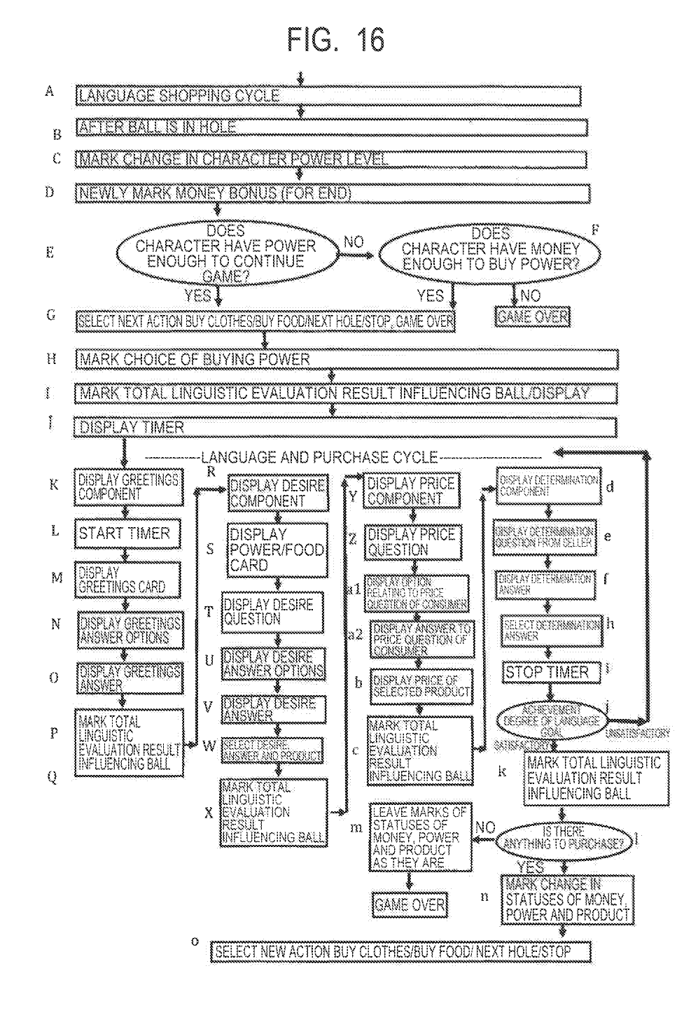

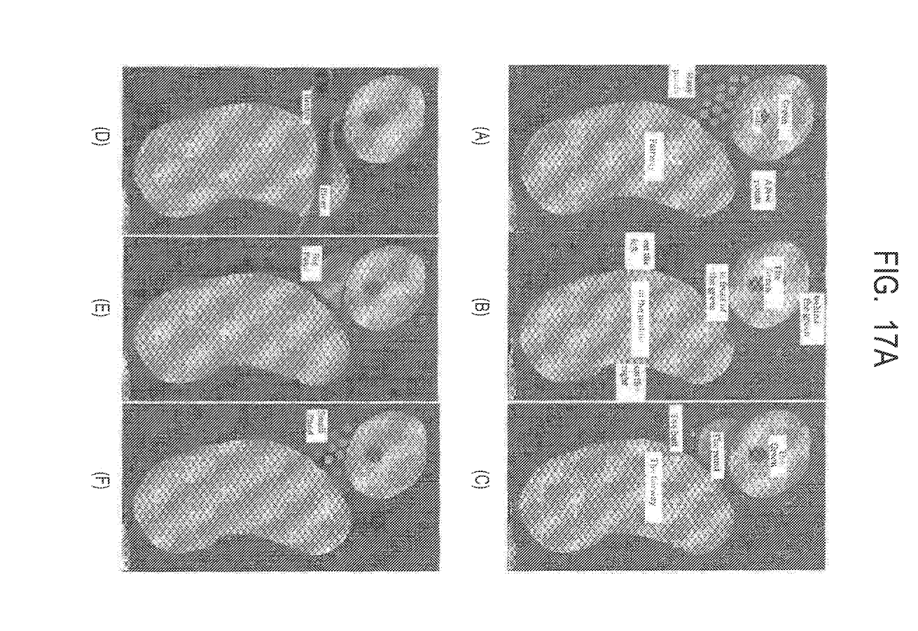

### (9) Language and Shopping Cycle (FIG. 16)—(Supported by Language and Shot Cycle)

### Another Patterned Speaking Structure for Shopping Power or Other Products

Another embodiment is illustrated in FIG. 16. A bonus to frequent playing is money bonus. As the player plays, the player loses power. The learner should buy power by money. Instead of buying power without using the language, the learned language is used in the structured role playing again, and shopping and buying the power is talked about. This cycle is called a “language and purchase cycle”. This enriches the learning experience and increases repetition.

The “language and purchase cycle” is made of components having language goals as in the “language and shot cycle”. The learner sequentially learns through these components by using the language from the content card in the question and answer and acts through latent purchase from the start to the end. The content card can have the same basic grammar as that of the language and shot cycle, but the other cards need to be designed for a new speaking goal in the language and shopping cycle in some cases.

In this embodiment, the “language and purchase cycle” is made of greetings, desires, prices, and determination. The learner starts at the “greetings component” and ends at the “determination component”. The greetings component is a basic method of practicing various greetings at shops. The question and answer relating to the greetings may be Hello, can I help you?/Yes, please or the like. The desire component is a basic method for practicing expression of a customer's desire at a shop. The question and answer relating to the desire may be Would you like some drink?/Yes, please or the like. The price component is a basic method for practicing various questions for asking the price. The question and answer relating to the price may be How much is it?/3 dollars or the like. Moreover, after the teacher's question “Do you know the price?”, the student's answer may be “No, I don't.”. Subsequently to that, a question “How much is it?” may be made by the student, and an answer “3 dollars.” may be made by the teacher. The determination component is a basic method for practicing transmission of determination to the shop. The question and answer relating to the greetings may be Determination: Do you want this?/Yes, I want it or the like.

In another embodiment, the power can be replaced by a health level, and after the language and shot cycle, the pattern language structure (language and health cycle) can be used for visiting a doctor or a drug store.

In another embodiment, the order of these components can be changed or increased.

In another embodiment, another component or preference is added for the student to express an emotion. The preference is also used for asking a question relating to products: shopping, clothes, golf clubs and the like. This data can be collected as research in documents or by using a program on the Internet.

In another embodiment, another component, desire is added for the student to express the desire of buying a product. The desire can be used for asking if the student wants the product concerning the product: shopping, clothes, golf clubs and the like. This data can be collected as research in documents or by using a program on the Internet. That can be means for connecting the game to a banner advertisement or a sponsor page.

In another embodiment, options of clothes relating to the character, products, foods and the like can be used for understanding preference of the learner. This information can be used for making better advertisement or targeted advertisement.

### (10) Influence of System Structure and Language on Shot (FIG. 15)

### (10-1) Play Surface (Game Field)

The play surface is a golf course, and a rectangle overlapped on it makes easy navigation and easy movement of the shot in accordance with the selected direction and shot card. A start location is a location where the first shot is made in the lower part of the surface. The student selects a start location. This selection does not need a conversation. A large black circle on the upper left is a hole or a finish. There are six rectangles in the circle in order to facilitate the game play.

In another embodiment, the course may be made by other geometric shapes such as a circle and an octagon.

In another embodiment, in addition to the board game, the system can be used in a role playing game, a video game, a video game between two users in different regions or point-to-point in browser.

In another embodiment, various locations on the course such as a fairway not influencing the ball and rough giving a bad influence to the ball to front/back/left/right based on a rough card. This card is taken after landing on the rough, and the ball is moved at random in accordance with the card.

In another embodiment, there can be one or more finish circles.

In another embodiment, the location on the surface can have a miscellaneous language question by which remuneration can be gained.

In another embodiment, the golf course is associated with a grid of 18 holes having a shop, a hospital, a parking lot, an airport, and other locations on the board. The other locations are for expanding use of the language by the other language cycles in the language and shot cycle.

In another embodiment, the game may be played on a huge play mat used in a nursery school, a kindergarten and the like instead of a board, and the card or a huge dice may be used for navigating the piece such as a ball.

### (10-2) Arrow Given to Ball

In order to navigate the course and to select the best direction, an arrow is given to the ball. There are left, straight and right arrows. A direction label on the arrow makes direction and language learning more intuitive.

In another embodiment, these language tips on the arrows can be removed.

### (10-3) Club

The club is displayed on the lower right, and the player selects the best club in order to make stroke amount the lowest from the start to the end.

In another embodiment, in a role playing game such as “DUNGEONS AND DRAGONS”, a dice can be used instead of moving the ball in another game.

### (10-4) Symbol List

A symbol list has some important abbreviations: A indicates an answer, O indicates a correct answer, X indicates a wrong answer, and Q indicates a question. Concerning each language and shot cycle, there are a club component and a direction component. The both have the questions (Q) and answers (A). A question No. 1 is abbreviated as Q1, an answer NO. 1 is abbreviated as A1 and the same applies to thereafter. Recording to the results can be made as in FIG. 8.

### (10-5) Measurement

The language goal uses the current progressive-form language card (ING). The language is measured in terms of accuracy and fluentness. Both the accuracy and fluentness influence the ball. The goal of accuracy is, as defined in the content card, use of the correct grammar both in the direction card and the club card.

In another embodiment, the accuracy can be measured by various methods. For example, measurement of the language accuracy, measurement of a language usage, measurement of language politeness or measurement of language pronunciation is included. The language accuracy can be measured with respect to the database of the content card on the computer or the content card on a hard drive.

In this figure, the goal of the fluentness is to finish each component in 2 minutes or less and measurement relating to both the direction card and club card by a stop watch. For each answer which has not achieved the goal of the accuracy or fluentness, the 2-yard penalty is imposed on the shot. In another embodiment, the ball can advance a distance other than 2 yards concerning each error. The first, second, and third shots: A broken line indicates a beginning shot, and a gray line indicates influences of accuracy and fluentness to the shot.

In another embodiment, an error can be added to a total score of the shot at the end.

In another embodiment, it may be so configured that the shot is influenced favorably by use of a language and a penalty is not imposed.

In another embodiment, the question may be a practice of the expression or may have multiple-choices. Whether the expression of the question is appropriate or whether the correct option has been selected is tested, and the result can influence the ball.

In the figure, the influence of the language on the ball, left or right and rear or front can be made by the number of shots which is an odd number or an even number.

In another embodiment, only the variable of either one of the accuracy and the fluentness can influence the shot.

In another embodiment, the bundle of cards can make the effect of the language on the shot at random. By means of the bundle of cards, the progress of the ball according to the accuracy and the fluentness is made at random.

In another embodiment, the result of neither of the fluentness nor the accuracy influences the shot. In this case, too, the ball is moved in an unpredictable way due to the shot card and the direction selection.

In another embodiment, the goal of the fluentness is set by selecting time required for completing the language and shot cycle and is described on the upper part of FIG. 8. When the fluentness is to be measured, it can be set and measured for each component or all the shot cycles.

In an embodiment of another game play, the accuracy and the fluentness or other variables can be used and influence the final score of the hole without influencing the shot.

In another embodiment, the penalty can be imposed on the shot by a poor play only after some language errors are made.

In another embodiment, the remuneration can be given to a shot by a useful shot and game play only after some correct answers are made.

In another embodiment, the learner can be required to take a penalty card after the language and shot cycle relating to a poor language result and the penalty is imposed on the shot in accordance with the card.

### (10-6) Power Level

The power level indicates a power amount the player currently has. The power is given by a bar. Each bar has three sub-bars made of drink, food, and dessert. The player starts the game by two bars as illustrated by the two green bars. Use of the correct language and favorable golf play give a low score. The low score is given remuneration by the power bars as follows: Eagle=5 bonus bars, birdie=3 bonus bars, par=2 bonus bars, bogey=1 bonus bar, double bogey=0 bonus bars.

Concerning this hole, it was three pars (indicating that you need to reach the hole in 3 strokes). This is marked by blue 3 in the middle of the list. By means of the power remuneration system, the learner gained a power bar as indicated by a red bar. As the power use system (dessert was arbitrarily exhausted) one sub-bar was exhausted concerning the hole and thus, one sub-bar is subtracted so as to be seen by a black sub-bar.

Each hole needs one sub-bar and thus, the player can play six holes by two green bars. If the player does not gain a bogey within the first six holes, the power is used up, and the game is finished. Limitation on the power means that motivation is further given to the language learner in order to achieve the proficiency level.

In another embodiment, the sub-bar can be changed from the power to money, and the learner collects money and buys the power in the language and shopping cycle.

In an embodiment of another money remuneration, extra money the player gains can be used for buying more power, a golf club or golf-wear. The club or the wear is useful for the golf play or gives more bonus points.

In another embodiment, the player can use money for buying better-quality food, and the food has a favorable influence on the ball.

In another embodiment, the language and game play can be used as means for performing a linguistic preparation exercise and for making preparation for using the language in other documents, a role play or a language program.

In another embodiment, the smaller power bars the learner has, the more desperate the shot should be. Therefore, an additional penalty card can be added to the language result of a predetermined power level. As a result, the learner is made to perform more role playing for buying food. If the power level is low, the accuracy or the fluentness has an influence, and its random effect can be increased. As a result, the learner's will concerning use of the shopping cycle is heightened.

In one embodiment, the result of a shopping role playing language can be added to the language and shot cycle.

In another embodiment, this system can be easily set up similarly through network, and the players play at the same time all over the world such that one of the players asks a question, and the other player answers the question. The language is replaced in order to reach a goal such as in Englishtown (U.S. Pat. No. 6,741,833, U.S. Pat. No. 7,058,354) and Rosetta Stone (U.S. Pat. No. 7,524,191). However, these patents do not focus on language replacement.

Furthermore, this language device is incorporated in a speaking device such as Skype for connecting the teacher and the learner or the learners.

In another embodiment, the results of the accuracy and the fluentness can be indicated by power bars instead of X or O in the list. If the results of the accuracy and the fluentness are perfect, the power bars are 100%.

In another embodiment, it may be so configured that evaluation results on two players (an evaluation result of at least one of the question and answer) influences the ball or the evaluation result (evaluation result of at least one of the question and answer) on one of the players influences the ball.

In another embodiment of two players, the language results of the two players can be compared, and positive results of the both, negative results of the both, a difference in the results of the two players, and a best result of the two players can influence the played ball.

In another configuration of the two players, both the accuracy and the fluentness, only the accuracy or only the fluentness influences the language result of the configuration of two players.

In another, the teacher or the computer can replace one language learner. In this situation, the computer plays a role of a counterpart of the language learner.

In one embodiment, the computer may ask questions and make answers by an influence of the language to the game without playing the game.

In one embodiment, the teacher or the computer plays the game, competes with the student and makes an error in the answer, whereby another answer as correct as possible is shown to the learner.

In another embodiment, it may be so configured that the play is made alternately depending on intensity of the learning or one player plays until the ball drops in the hole and then, it is determined whether another person will play or not. The latter also helps consistent repetitious practice of the learner.

In another embodiment, the language goal may be an advice before a component of the language and shot cycle. In this case, the questioner may be a type of an instructor or a coach of an answerer/shooter. If the language or its use of the questioner is good, the result can influence the answer/shooter or they can influence the shot in the next play. Moreover, in an appropriate step of the shot cycle, the questioner can give an advice to a shooter. This advice (ADVICE COMPONENT) may be expressions such as “How about . . . ?”, “Why don't you . . . ?” and the like. Moreover, a general conversation may be inserted in the shot cycle as appropriate.

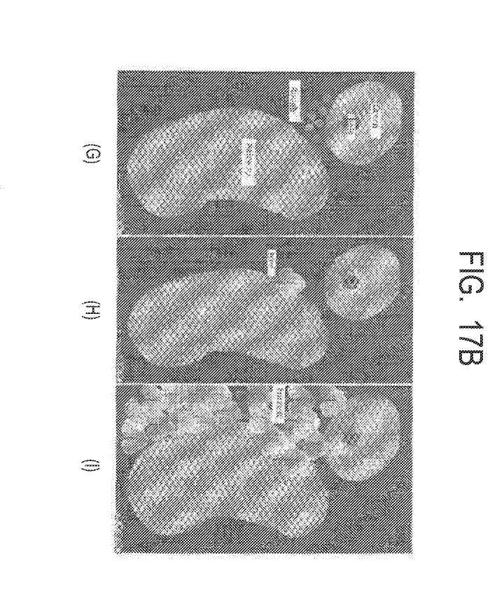

### (11) Introduce More Languages by Course Design (FIG. 17A and FIG. 17B)

To add a new object on the course can increase vocabulary of the student. Addition of intuitive objects, such as a tree, a forest, a pond, a big pond, a bridge, a list of animals in rivers, fruits, vegetables, mushroom, a snowman, or of objects known all over the world to the game can expedite learning. If only one object is introduced once, the learner can estimate association between the new object and the language quickly. For example, if the ball is near a big pond, and the big pond is only the new object and the other game objects are known, the student can associate the word of the large pond to the object.

In one embodiment, with the purpose of easy language introduction, multiple-choices indicate new and known languages and are good at comparing them and thus, the multiple-choices can be used in the question and answer. In addition of seeing a new language in the game, the learner can associate the new language and the new objects by a learner who is watching the new language in the multiple-choices.

FIG. 17A and FIG. 17B illustrate another embodiment of the language introduction. A label on the course near the new object associates the language with the vocabulary. By placing the label of a new word “Big pond” on or near the object, the learner can estimate that the new object is a big pond. This enables understanding of the language by the learner without spending time in the language introduction.

In another embodiment, before the new object is added to the course and before the game play, practice can be made before a flash card having the new object adds the object to the language and shot cycle. Moreover, the flash card can be supported also by the language label added to the course.

In a future embodiment, through a support of a computer and a touch screen or a click, the learner can show the card, the word, and the meaning by clicking a golf screen for the new object.

In one embodiment, the language and the object used by the learner can control progress of the game. For example, in a conversation in the shot cycle, if an answerer answers “I am aiming for the tree”, the ball is directed to the direction of the tree or the like.

In another embodiment, use of a golf surface such as a tunnel which is not traditional and an object such as a mystery card gives another language option for increasing the learning and the game play.

In another embodiment of a non-ordinary surface, the role playing can be incorporated in a special space under the “talk” component. One or more spaces are based on themes such as weather. The space can have an icon like autumn. The learner selects an answer for depicting the autumn weather as follows in a mini role playing.: How is the weather? A cold, B cool, C hot, What is a temperature? Approximately A 0 to 10 degrees Celsius, B 10 to 20 degrees Celsius, C 20 to 30 degrees Celsius.

Another embodiment is a course design not using traditional golf objects and obstacles. The game can have a tunnel to be given to the learner, a weather object or mystery card, learn new words, and use various vocabularies.

In another embodiment, the course may be a movable obstacle or hazard. In one situation, the obstacle may be an animal which can be placed on the course, and they are moved during the game play and are incorporated in the game play and the language learning.

In another embodiment, the “talk” can be used to incorporate speaking in the game. For example, talk—question: What is that? answer: That is a pig. That is a giraffe. That is a snake. Talk: question—What is the snake doing? answer: It is biting, it is eating, and it is swimming. In each game play after the language and shot cycle, a movable object can make one movement at the same time or at one time to left, right, front or rear in accordance with a set of cards relating to animals. Moreover, the animal may be a special hazard and may give additional points or end the game.

### REFERENCE SIGNS LIST

10 operation portion, 12 speaker, 14 microphone, 16 display portion, 18 device body portion, 20 question providing portion, 22 answer recognition portion, 24 execution portion, 26 image generating portion, 28 storage portion, 30 direction content card, 32 club content card, 34 club distance card, 36 game field, 38 piece, 40 evaluation sheet, 42 goal region, 44 start position.

1. A language practice device comprising:
a question providing portion configured to provide a question to a learner in a language to be learned;
an answer recognition portion configured to recognize an answer to the question; and
an execution portion configured to execute a game based on the answer, wherein
the execution portion executes element steps constituting the game based on a linguistic evaluation of the answer.

2. The language practice device according to claim 1, wherein
the element steps include:
an advancing step for determining an advancing direction or an advancing distance of a piece used in the game based on the linguistic evaluation of the answer; and
a position determining step for determining a position of the piece in accordance with the advancing step; and
the question providing portion provides a question element for determining the advancing direction or a question element for determining the advancing distance as the question.

3. A language teaching material comprising:
a bundle of cards including a plurality of cards; and
a field on which a figure indicating a progress state of a game is shown, wherein each of the cards describes a question to a learner or information for identifying the predetermined question to the learner determined in advance; and
the question includes contents for executing element steps constituting the game.

4. The language teaching material according to claim 3, wherein
the element steps include an advancing step for determining an advancing direction or an advancing distance of a piece on the field; and
the question includes a question element for determining the advancing direction or the advancing distance.

5. A language practice program causing a computer to execute:
question providing processing of providing a question to a learner in a language to be learned:
answer recognition processing of recognizing an answer to the question; and
execution processing of executing a game based on the answer, wherein
the execution processing executes element steps constituting the game based on a linguistic evaluation of the answer.
